(19) United States
(12) Patent Application Publication
(10) Pub. No.: US 2025/0284218 A1
(43) Pub. Date: Sep. 11, 2025

(54) ELECTROSTATIC CHARGE IMAGE DEVELOPING TONER, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Daisuke NAKASHIMA, Kanagawa (JP); Yukiko KAMIJO, Kanagawa (JP); Masahiro TAKAYAMA, Kanagawa (JP); Yuka ISHIHARA, Kanagawa (JP); Masashi IKEDA, Kanagawa (JP); Koji FUNABA, Kanagawa (JP); Reina MURANO, Kanagawa (JP); Yuko HIRANO, Kanagawa (JP)

(73) Assignee: FUJIFILM Business Innovation Corp., Tokyo (JP)

(21) Appl. No.: 18/922,459

(22) Filed: Oct. 22, 2024

(30) Foreign Application Priority Data
Mar. 7, 2024 (JP) 2024-035289

(51) Int. Cl. G03G 9/08; G03G 21/16; G03G 21/18

(52) U.S. Cl. CPC G03G 9/0827; G03G 9/0819; G03G 21/1676; G03G 21/1814; G03G 2215/066

(57) ABSTRACT

An electrostatic charge image developing toner contains toner particles, in which, with respect to entire particles of the electrostatic charge image developing toner, an existence proportion of particles having a particle size of 4.5 μm or more and 7.5 μm or less and a circularity of less than 0.930 is 0.1% by number or more and 5.0% by number or less, and an existence proportion of particles having a particle size of 4.5 μm or more and 7.5 μm or less and a circularity of more than 0.950 and less than 0.990 is 59% by number or more and 80% by number or less.

### CROSS-REFERENCE TO RELATED APPLICATIONS

This application is based on and claims priority under 35 USC 119 from Japanese Patent Application No. 2024-035289 filed Mar. 7, 2024.

### BACKGROUND

### (i) Technical Field

The present invention relates to an electrostatic charge image developing toner, an electrostatic charge image developer, a toner cartridge, a process cartridge, an image forming apparatus, and an image forming method.

### (ii) Related Art

JP2008-225120A discloses an electrostatic charge developing toner, in which an average circularity is 0.94 or more and 0.98 or less, a circularity of particles with 90% of a cumulative equivalent circle diameter counted from a smaller side in terms of the number is less than 0.92, a proportion of particles having a circularity of less than 0.92 is less than 3% by number with respect to the entire toner, a proportion of particles having a circularity of 0.90 or more and less than 0.95 is 20% or more and 40% or less with respect to the entire toner, and a proportion of particles having a circularity of 0.95 or more and 1.00 or less is 60% or more and 80% or less with respect to the entire toner.

JP1999-305477A discloses a negatively charged toner that contains at least toner particles, inorganic fine powder, and resin fine particles, in which the toner particles contain at least a binder resin and a colorant, in a particle size distribution based on an equivalent circle diameter of the toner particles, a proportion of particles having an equivalent circle diameter of 0.60 μm or more and less than 1.00 μm is less than 5.0% in terms of the number with respect to the total, a number-average equivalent circle diameter of the toner particles is 4.0 to 10.0 μm, the resin fine particles have an average particle size of 0.05 to 2.0 μm, and a shape factor SF-1 of the resin fine particles is 100 or more and less than 150 and a shape factor SF-2 of the resin fine particles is 110 or more and less than 200.

### SUMMARY

Aspects of non-limiting embodiments of the present disclosure relate to an electrostatic charge image developing toner that has improved transferability of a solid image in a high-temperature and high-humidity environment, compared to a case where an existence proportion of particles having a particle size of 4.5 μm or more and 7.5 μm or less and a circularity of less than 0.930 is less than 0.1% by number or more than 5.0% by number, or a case where an existence proportion of particles having a particle size of 4.5 μm or more and 7.5 μm or less and a circularity of more than 0.950 and less than 0.990 is less than 59% by number or more than 80% by number.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above-described object include the following aspects.

According to an aspect of the present disclosure, there is provided an electrostatic charge image developing toner containing toner particles, in which, with respect to entire particles of the electrostatic charge image developing toner, an existence proportion of particles having a particle size of 4.5 μm or more and 7.5 μm or less and a circularity of less than 0.930 is 0.1% by number or more and 5.0% by number or less, and an existence proportion of particles having a particle size of 4.5 μm or more and 7.5 μm or less and a circularity of more than 0.950 and less than 0.990 is 59% by number or more and 80% by number or less.

### BRIEF DESCRIPTION OF THE DRAWINGS

Exemplary embodiment(s) of the present invention will be described in detail based on the following figures, wherein:

FIG. 1 is a view schematically showing the configuration of an example of an image forming apparatus according to the present exemplary embodiment; and

FIG. 2 is a view schematically showing the configuration of an example of a process cartridge detachable from the image forming apparatus according to the present exemplary embodiment.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit value or lower limit value of a numerical range may be replaced with the upper limit value or lower limit value of another numerical range described in stages. Furthermore, in the present disclosure, the upper limit value or lower limit value of a numerical range may be replaced with values described in examples.

In the present disclosure, the term “step” includes not only an independent step but a step that is not clearly distinguished from other steps as long as the intended purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present disclosure, “(meth)acrylic” means at least one of acrylic or methacrylic, and “(meth)acrylate” means at least one of acrylate or methacrylate.

### Electrostatic Charge Image Developing Toner

The electrostatic charge image developing toner (hereinafter, also simply referred to as “toner”) according to the present exemplary embodiment contains toner particles, in which, with respect to entire particles of the toner, an existence proportion of particles having a particle size of 4.5 μm or more and 7.5 μm or less and a circularity of less than 0.930 is 0.1% by number or more and 5.0% by number or less, and an existence proportion of particles having a particle size of 4.5 μm or more and 7.5 μm or less and a circularity of more than 0.950 and less than 0.990 is 59% by number or more and 80% by number or less.

Hereinafter, the toner particles having a particle size of 4.5 μm or more and 7.5 μm or less are referred to as “specific-sized particles”; the existence proportion of the specific-sized particles having a circularity of less than 0.930 with respect to entire particles of the toner is referred to as “low circularity proportion”, and the existence proportion of the specific-sized particles having a circularity of more than 0.950 and less than 0.990 with respect to entire particles of the toner is referred to as “high circularity proportion”.

In the present exemplary embodiment, transferability of a solid image in a high-temperature and high-humidity environment (hereinafter, also referred to as “high-temperature and high-humidity solid image transferability”) is improved by setting the low circularity proportion and the high circularity proportion to be within the above-described ranges, respectively. The reason is not clear, but is presumed as follows.

In image formation using a toner, for example, a toner image formed on a surface of an image holder is transferred to an intermediate transfer member as necessary, and then the toner image is transferred to a surface of a recording medium.

In order to form a solid image having a high image density, high transferability of a toner image is required. On the other hand, in a case where a solid image is formed in a high-temperature and high-humidity environment, a non-electrostatic adhesion force between the toner image and a surface in contact with the toner image (for example, the surface of the image holder or the surface of the intermediate transfer member) tends to be high, and the high transferability is difficult to obtain. For example, a toner having a low circularity is likely to have a large contact area with the surface to which the toner image comes into contact, and is likely to have higher non-electrostatic adhesion force described above. In addition, in a toner image formed of a toner having a high circularity, color loss due to partial toner aggregation may occur during the transfer.

On the other hand, in the present exemplary embodiment, the high circularity proportion is 59% by number or more and 80% by number or less, and the low circularity proportion is 0.1% by number or more and 5.0% by number or less. That is, the specific-sized particles having a high circularity occupy a large proportion of the toner, and the specific-sized particles having a low circularity with an irregular shape are slightly contained in the toner. Therefore, in the toner image, a structure in which particles are densely packed (hereinafter referred to as “high-density filling structure”) is easily formed by filling in gaps of a structure in which the specific-sized particles having a high circularity are filled with the specific-sized particles having a low circularity. In the step of transferring the toner image having the high-density filling structure to the surface of the recording medium, the toner image is easily separated from the surface without breaking the high-density filling structure due to the adhesion force between the particles of the toner. Therefore, it is considered that the color loss is less likely to occur and the high transferability can be achieved.

For the above reasons, in the present exemplary embodiment, it is presumed that the high-temperature and high-humidity solid image transferability is improved.

### Particle Size and Circularity of Toner

Here, the particle size and the circularity of the toner are measured using a flow-type particle image analyzer FPIA-3000 (manufactured by Sysmex Corporation). The number of samples of the toner is set to 4,500, the measurement range of the particle size is set to 0.5 μm or more and 200 μm or less, and the measurement range of the circularity is set to 0.200 or more and 1.000 or less. An average equivalent circle diameter in a projection image of the particles is defined as the particle size of the toner, and a number average of the particle sizes of the 4,500 toner particles is defined as the number-average particle size of the toner. The circularity of the toner is obtained by (Circumference length equivalent to circle)/(Circumference length), that is, (Circumference length of circle having the same projected area as the projection image of the particles)/(Circumference length of the projection image of the particles); and a number average of the circularities of the 4,500 toner is defined as the average circularity of the toner. The proportion of particles in each range of the particle size and the circularity is obtained from distribution analysis of the measurement data.

In a case where the toner is a toner in which an external additive adheres to the surface of the toner particles, the particle size and the circularity of the toner are values measured for the toner to which the external additive adheres.

The low circularity proportion is 0.1% by number or more and 5.0% by number or less as described above, and from the viewpoint of improving the high-temperature and high-humidity solid image transferability, the low circularity proportion is, for example, preferably 0.1% by number or more and 1.5% by number or less, and more preferably 0.5% by number or more and 1.3% by number or less.

In a case where the low circularity proportion is equal to or more than the above-described lower limit value, it is presumed that the specific-sized particles having a low circularity sufficiently fills the gaps of the structure in which the specific-sized particles having a high circularity are packed, and thus the high-density filling structure is easily formed and the high-temperature and high-humidity solid image transferability is improved. In addition, in a case where the low circularity proportion is equal to or less than the above-described upper limit value, it is presumed that the high-temperature and high-humidity solid image transferability is improved by suppressing collapse of the high-density filling structure due to the fact that the proportion of the specific-sized particles having a low circularity is too high.

The high circularity proportion is 59% by number or more and 80% by number or less as described above, and from the viewpoint of improving the high-temperature and high-humidity solid image transferability, the high circularity proportion is, for example, preferably 62% by number or more and 78% by number or less, and more preferably 65% by number or more and 75% by number or less.

In a case where the high circularity proportion is equal to or more than the above-described lower limit value, it is presumed that the high-temperature and high-humidity solid image transferability is improved by suppressing deterioration of the transferability due to the fact that the particle size distribution of the toner is excessively large. In addition, in a case where the high circularity proportion is equal to or less than the above-described upper limit value, it is presumed that the high-temperature and high-humidity solid image transferability is improved by suppressing the color loss caused by partial toner aggregation due to the fact that the proportion of the specific-sized particles having a high circularity is too high.

From the viewpoint of improving the high-temperature and high-humidity solid image transferability, the low circularity proportion is, for example, preferably 0.001 times or more and 0.065 times or less, more preferably 0.004 times or more and 0.030 times or less, and still more preferably 0.007 times or more and 0.020 times or less of the high circularity proportion. That is, a ratio (low circularity proportion/high circularity proportion) of the low circularity proportion to the high circularity proportion is, for example, preferably 0.001 or more and 0.065 or less, more preferably 0.004 or more and 0.030 or less, and still more preferably 0.007 or more and 0.020 or less.

In a case where the ratio (low circularity proportion/high circularity proportion) is equal to or more than the above-described lower limit value, it is presumed that the high-density filling structure is easily formed and the high-temperature and high-humidity solid image transferability is improved. In addition, in a case where the ratio (low circularity proportion/high circularity proportion) is equal to or less than the above-described upper limit value, it is presumed that the high-temperature and high-humidity solid image transferability is improved by suppressing the collapse of the high-density filling structure.

A method of controlling the low circularity proportion and the high circularity proportion to be within the above-described ranges is not particularly limited. For example, in a case where the toner particles are manufactured by an aggregation and coalescence method described later, the low circularity proportion and the high circularity proportion may be controlled by adjusting an amount of an acid added in a coalescence step, a stirring speed at the time of adding the acid, a retention time, and the like. In addition, the low circularity proportion and the high circularity proportion may be controlled by adding specific-sized particles having adjusted circularity (for example, specific-sized particles having a circularity of less than 0.930, specific-sized particles having a circularity of more than 0.950 and less than 0.990, and the like).

From the viewpoint of improving the high-temperature and high-humidity solid image transferability, an existence proportion of particles having a particle size of 4.5 μm or more and 7.5 μm or less and a circularity of 0.990 or more is, for example, preferably 8% by number or less, more preferably 6% by number or less, and still more preferably 5.5% by number or less with respect to entire particles of the toner. From the viewpoint that it is easy to form the structure in which the specific-sized particles having a high circularity are packed, the existence proportion of particles having a particle size of 4.5 μm or more and 7.5 μm or less and a circularity of 0.990 or more is, for example, preferably 2% by number or more, more preferably 3% by number or more, and still more preferably 4% by number or more with respect to entire particles of the toner.

From the viewpoint of increasing a filling ratio during formation of a solid image and balancing a charging control, a number-average particle size of the toner is, for example, preferably 4.5 μm or more and 7.5 μm or less, more preferably 5.0 μm or more and 7.0 μm or less, and still more preferably 5.5 μm or more and 6.5 μm or less.

The existence proportion of the specific-sized particles with respect to the entire toner is, for example, 65% by number or more and 86% by number or less, and from the viewpoint of the proportion of the particles having a high circularity, the existence proportion of the specific-sized particles is, for example, preferably 70% by number or more and 83% by number or less, and more preferably 74% by number or more and 80% by number or less.

In addition, from the viewpoint of improving the high-temperature and high-humidity solid image transferability, an average circularity of the toner is, for example, preferably more than 0.95 and 0.99 or less, more preferably 0.960 or more and 0.983 or less, and still more preferably 0.965 or more and 0.980 or less. In a case where the average circularity of the toner is equal to or more than the above-described lower limit value, it is presumed that the high-temperature and high-humidity solid image transferability is improved by suppressing the increase in non-electrostatic adhesion force due to the fact that the contact area is large. In addition, in a case where the average circularity of the toner is equal to or less than the above-described upper limit value, it is presumed that the high-temperature and high-humidity solid image transferability is improved by suppressing the color loss caused by the partial toner aggregation.

### Halogen Element

In the present exemplary embodiment, for example, it is preferable that the toner particles contain a halogen element. In a case where the low circularity proportion and the high circularity proportion of the toner are each within the above-described range and the toner particles contain a halogen element, the high-temperature and high-humidity solid image transferability is further improved.

It is presumed that the reason why the high-temperature and high-humidity solid image transferability is improved by containing a halogen element in the toner particles is that the presence of the halogen element increases a retention force of electrons in the toner particles, and thus the decrease in transfer efficiency due to charge leakage during transfer is suppressed.

Examples of the halogen element include bromine, chlorine, iodine, and fluorine. The toner particles may contain only one kind of halogen element or may contain two or more kinds of halogen elements. From the viewpoint of improving an electron retention force, as the halogen element, for example, the toner particles preferably contain at least one selected from the group consisting of bromine, chlorine, and iodine; more preferably contain at least one of bromine or chlorine; and still more preferably contain bromine.

In a case where the toner particles contain at least one selected from the group consisting of bromine, chlorine, and iodine, the polarity of the toner is less likely to be excessively increased than a case where the toner particles contain only fluorine as the halogen element. It is presumed that the charge leakage during transfer, that is likely to occur due to the high polarity of the toner, is suppressed by attraction of moisture, and the high-temperature and high-humidity solid image transferability is further improved. In addition, in a case where the toner particles contain at least one of bromine or chlorine, it is presumed that the effect of improving the electron retention force of the toner particles is higher than a case where the toner particles contain only iodine as the halogen element, and the high-temperature and high-humidity solid image transferability is further improved.

From the viewpoint of improving the high-temperature and high-humidity solid image transferability, an abundant amount of the halogen element (hereinafter, also referred to as “halogen amount”) per 100 g of the toner is, for example, preferably 0.25 millimoles or more and 12.5 millimoles or less, more preferably 0.63 millimoles or more and 6.25 millimoles or less, and still more preferably 1.25 millimoles or more and 3.75 millimoles or less.

It is presumed that the reason why the high-temperature and high-humidity solid image transferability is improved by setting the halogen amount to be equal to or more than the above-described lower limit value is that the effect of improving the electron retention force by the halogen element is likely to be obtained as compared with a case where the halogen amount is less than the above-described lower limit value. In addition, it is presumed that the reason why the high-temperature and high-humidity solid image transferability is improved by setting the halogen amount to be equal to or less than the above-described upper limit value is that the polarity of the toner is less likely to be excessively increased as compared with a case where the halogen amount is more than the above-described upper limit value.

In a case where the toner particles contain two or more kinds of halogen elements, the above-described halogen amount means the total abundant amount of the two or more kinds of halogen elements contained in the toner particles.

From the viewpoint of improving the high-temperature and high-humidity solid image transferability, an abundant amount of bromine (hereinafter, also referred to as “bromine amount”) with respect to the entire toner is, for example, preferably 0.02% by mass or more and 1.0% by mass or less, more preferably 0.05% by mass or more and 0.50% by mass or less, and still more preferably 0.10% by mass or more and 0.30% by mass or less.

In a case where the bromine amount is equal to or more than the above-described lower limit value, it is presumed that the effect of improving the electron retention force by bromine is likely to be obtained; and in a case where the bromine amount is equal to or less than the above-described upper limit value, it is presumed that the polarity of the toner is less likely to be excessively increased, so that the high-temperature and high-humidity solid image transferability is improved.

From the viewpoint of improving the high-temperature and high-humidity solid image transferability, an abundant amount of chlorine (hereinafter, also referred to as “chlorine amount”) with respect to the entire toner is, for example, preferably 0.009% by mass or more and 0.45% by mass or less, more preferably 0.02% by mass or more and 0.23% by mass or less, and still more preferably 0.04% by mass or more and 0.14% by mass or less.

In a case where the chlorine amount is equal to or more than the above-described lower limit value, it is presumed that the effect of improving the electron retention force by chlorine is likely to be obtained; and in a case where the chlorine amount is equal to or less than the above-described upper limit value, it is presumed that the polarity of the toner is less likely to be excessively increased, so that the high-temperature and high-humidity solid image transferability is improved.

From the viewpoint of improving the high-temperature and high-humidity solid image transferability, an abundant amount of iodine (hereinafter, also referred to as “iodine amount”) with respect to the entire toner is, for example, preferably 0.032% by mass or more and 1.59% by mass or less, more preferably 0.08% by mass or more and 0.79% by mass or less, and still more preferably 0.16% by mass or more and 0.48% by mass or less.

In a case where the iodine amount is equal to or more than the above-described lower limit value, it is presumed that the effect of improving the electron retention force by iodine is likely to be obtained; and in a case where the iodine amount is equal to or less than the above-described upper limit value, it is presumed that the polarity of the toner is less likely to be excessively increased, so that the high-temperature and high-humidity solid image transferability is improved.

The abundant amount of each element in the toner is obtained by measurement using a fluorescent X-ray analyzer (ZSX Primus2 manufactured by Rigaku Corporation).

A measurement sample is prepared by press-molding 4 g of the toner to be measured in a press-molding device under conditions of 10 t for 1 minute, and molding the toner into a disk shape having a diameter of 50 mm.

As measurement conditions, the tube voltage, the tube current, the spectroscopic crystal, and the slit predetermined by the device are selected for each element.

A quantitative value of the abundant amount of each element is obtained by creating a calibration curve from a measured value of a calibration sample. For example, in a case of measuring the abundant amount of bromine, potassium bromide is finely ground in a mortar, and a toner in which the mass ratio of potassium bromide is uniformly mixed at three levels is prepared and used as a calibration sample. Next, the measurement sample is prepared by the above-described method using 4 g of each of these calibration samples, and the measurement is performed under the same conditions as the measurement sample of the toner to be measured, thereby obtaining a calibration curve of an X-ray detection intensity and a bromine content. Examples of a reference material for measuring the abundant amount of bromine include salts such as potassium bromide and alkylammonium bromide, and reagents having a predetermined purity, but the reference material is not limited thereto.

Examples of the method of controlling the halogen amount in the toner include a method of adding a compound containing a halogen element (hereinafter, also referred to as “halogen-containing compound”) in a manufacturing process of the toner, and adjusting the amount of the compound added. Among halogen-containing compounds, an amount of a compound containing bromine (hereinafter, also referred to as “bromine-containing compound”) to be added is adjusted to control the halogen amount and the bromine amount. Similarly, among halogen-containing compounds, an amount of a compound containing chlorine (hereinafter, also referred to as “chlorine-containing compound”) to be added is adjusted to control the halogen amount and the chlorine amount. Similarly, among halogen-containing compounds, an amount of a compound containing iodine (hereinafter, also referred to as “iodine-containing compound”) to be added is adjusted to control the halogen amount and the iodine amount.

Examples of the bromine-containing compound include ammonium salts such as dodecyltrimethylammonium bromide, benzyl dodecyldimethylammonium bromide, and ammonium bromide; and metal salts such as potassium bromide, aluminum bromide, and magnesium bromide.

Examples of the chlorine-containing compound include ammonium salts such as dodecyltrimethylammonium chloride, benzyl dodecyldimethylammonium chloride, and ammonium chloride; and metal salts such as potassium chloride, aluminum chloride, and magnesium chloride.

Examples of the iodine-containing compound include ammonium salts such as dodecyltrimethylammonium iodide, benzyl dodecyldimethylammonium iodide, and ammonium iodide; and metal salts such as potassium iodide, aluminum iodide, and magnesium iodide.

Examples of the fluorine-containing compound include metal salts such as sodium monofluorophosphate and sodium fluoride.

Hereinafter, the toner according to the present exemplary embodiment will be described in detail.

The toner according to the present exemplary embodiment contains toner particles. The toner according to the present exemplary embodiment may contain an external additive.

### Toner Particles

The toner particles contain, for example, a resin. The toner particles may contain a colorant, a release agent, other additives, and the like.

### Resin

Examples of the resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these resins may be used alone, or two or more kinds of these resins may be used in combination.

As the resin, for example, a polyester resin is suitable.

Examples of the polyester resin include known amorphous polyester resins. As the polyester resin, a crystalline polyester resin may be used in combination with an amorphous polyester resin. However, a content of the crystalline polyester resin may be, for example, in a range of 2% by mass or more and 40% by mass or less (for example, preferably 2% by mass or more and 25% by mass or less) with respect to all resins.

The “crystalline” resin indicates that a clear endothermic peak is present in differential scanning calorimetry (DSC) rather than a stepwise change in endothermic amount and specifically indicates that the half-width of the endothermic peak in a case of measurement at a temperature rising rate of 10 (C/min) is within 10° C.

On the other hand, the “amorphous” resin indicates that the half-width is higher than 10° C., a stepwise change in endothermic amount is shown, or a clear endothermic peak is not recognized.

### Amorphous Polyester Resin

Examples of the amorphous polyester resin include a polycondensate of a polyvalent carboxylic acid and a polyhydric alcohol. As the amorphous polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, orthophthalic acid, naphthalenedicarboxylic acid, and the like), anhydrides of these, and lower alkyl esters (for example, having 1 or more and 5 or less carbon atoms). Among these, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the polyhydric alcohols, for example, an aromatic diol or an alicyclic diol is preferable, and an aromatic diol is more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One kind of polyhydric alcohol may be used alone, or two or more kinds of polyhydric alcohols may be used in combination.

The glass transition temperature (Tg) of the amorphous polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

The weight-average molecular weight (Mw) of the amorphous polyester resin is, for example, preferably 5,000 or more and 1,000,000 or less, and more preferably 7,000 or more and 500,000 or less.

The number-average molecular weight (Mn) of the amorphous polyester resin is, for example, preferably 2,000 or more and 100,000 or less.

The molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC⋅HLC-8120GPC manufactured by Tosoh Corporation as a measurement device, TSKgel Super HM-M (15 cm) manufactured by Tosoh Corporation as a column, and THF as a solvent. The weight-average molecular weight and the number-average molecular weight are calculated using a molecular weight calibration curve plotted using a monodisperse polystyrene standard sample from the measurement results.

The amorphous polyester resin is obtained by a well-known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the reaction, for example, the monomer with poor compatibility may be condensed in advance with an acid or an alcohol that is to be polycondensed with the monomer, and then polycondensed together with the main component.

### Crystalline Polyester Resin

Examples of the crystalline polyester resin include a polycondensate of polyvalent carboxylic acid and polyhydric alcohol. As the crystalline polyester resin, a commercially available product or a synthetic resin may be used.

Here, since the crystalline polyester resin easily forms a crystal structure, the crystalline polyester resin is, for example, preferably a polycondensate that is not formed of an aromatic-containing polymerizable monomer but is formed of a linear aliphatic polymerizable monomer.

Examples of the polyvalent carboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (such as dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 7 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among the aliphatic diols, for example, 1,8-octanediol, 1,9-nonanediol, or 1,10-decanediol is preferable.

As the polyhydric alcohol, an alcohol having a valency of 3 or more, that forms a crosslinked structure or a branched structure, may be used in combination with the diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

Here, the content of the aliphatic diol in the polyhydric alcohol may be 80% by mole or more and, for example, preferably 90% by mole or more.

The melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

The weight-average molecular weight (Mw) of the crystalline polyester resin is, for example, preferably 6,000 or more and 35,000 or less.

The crystalline polyester resin can be obtained by a well-known manufacturing method, for example, same as the amorphous polyester resin.

In a case where the resin contains a polyester resin, a content of the polyester resin with respect to the entire resin is, for example, 20% by mass or more and 100% by mass or less, preferably 40% by mass or more and 100% by mass.

Examples of the resin also include a vinyl-based resin.

The vinyl-based resin will be described.

Examples of the vinyl-based resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

One kind of each of these vinyl-based resins may be used alone, or two or more kinds of these vinyl-based resins may be used in combination.

As the vinyl-based resin, for example, a styrene acrylic resin is preferable from the viewpoint of excellent environmental stability of toner charging.

The styrene acrylic resin is a copolymer obtained by copolymerizing at least a styrene-based monomer (a monomer having a styrene skeleton) and a (meth)acrylic monomer (a monomer containing a (meth)acryloyl group and, for example, preferably a monomer containing a (meth)acryloyloxy group). The styrene acrylic resin includes, for example, a copolymer of a monomer of styrenes and a monomer of (meth)acrylic acid esters described above. The acrylic resin portion in the styrene acrylic resin is any one of an acrylic monomer or a methacrylic monomer, or a partial structure obtained by polymerizing the monomers. In addition, “(meth)acrylic” is an expression including both of “acrylic” and “methacrylic”.

Specific examples of the styrene-based monomer include styrene, alkyl-substituted styrene (such as α-methylstyrene, 2-methylstyrene, 3-methylstyrene, 4-methylstyrene, 2-ethylstyrene, 3-ethylstyrene, and 4-ethylstyrene), halogen-substituted styrene (such as 2-chlorostyrene, 3-chlorostyrene, and 4-chlorostyrene), and vinylnaphthalene. The styrene-based monomer may be used alone or in combination of two or more kinds thereof.

Among these, from the viewpoint of ease of reaction, ease of control of reaction, and availability, as the styrene-based monomer, for example, styrene is preferable.

Specific examples of the (meth)acrylic monomer include (meth)acrylic acid and (meth)acrylic acid ester. Examples of the (meth)acrylic acid ester include (meth)acrylic acid alkyl ester (such as methyl (meth)acrylate, ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, cyclohexyl (meth)acrylate, and t-butylcyclohexyl (meth)acrylate), (meth)acrylic acid aryl ester (such as phenyl (meth)acrylate, biphenyl (meth)acrylate, diphenylethyl (meth)acrylate, t-butylphenyl (meth)acrylate, and terphenyl (meth)acrylate); dimethylaminoethyl (meth)acrylate, diethylaminoethyl (meth)acrylate, methoxyethyl (meth)acrylate, 2-hydroxyethyl (meth)acrylate, β-carboxyethyl (meth)acrylate, and (meth)acrylamide. The (meth)acrylic monomer may be used alone or in combination of two or more kinds thereof.

Among the (meth)acrylic monomers, from the viewpoint of improving the fixability of the toner, for example, (meth)acrylic acid ester containing an alkyl group having 2 or more and 14 or less carbon atoms (for example, preferably 2 or more and 10 or less carbon atoms and more preferably 3 or more and 8 or less carbon atoms) is preferable among the (meth)acrylic esters. Among these, for example, n-butyl (meth)acrylate is preferable, and n-butyl acrylate is particularly preferable.

The copolymerization ratio of the styrene-based monomer to the (meth)acrylic monomer (on a mass basis, styrene-based monomer/(meth)acrylic monomer) is not particularly limited, but is preferably 98/2 to 60/40.

From the viewpoint of improving the fixability of the toner, the glass transition temperature (Tg) of the styrene acrylic resin is, for example, preferably 40° C. or higher and 75° C. or lower, and more preferably 50° C. or higher and 65° C. or lower.

Here, the glass transition temperature of the resin is determined from a DSC curve obtained by the differential scanning calorimetry (DSC). More specifically, the glass transition temperature of the resin is determined by “extrapolated glass transition onset temperature” described in the method for determining a glass transition temperature in JIS K 7121:1987, “Testing methods for transition temperatures of plastics”.

From the viewpoint of storage stability of the toner, the weight-average molecular weight of the styrene acrylic resin is, for example, preferably 5,000 or more and 200,000 or less, more preferably 10,000 or more and 100,000 or less, and still more preferably 20,000 or more and 80,000 or less.

A method of producing the styrene acrylic resin is not particularly limited, and various polymerization methods (for example, solution polymerization, precipitation polymerization, suspension polymerization, bulk polymerization, and emulsion polymerization) are applied. In addition, a known operation (for example, a batch type, semi-continuous type, or continuous type operation) is applied to the polymerization reaction.

For example, the toner particles preferably contain at least one selected from the group consisting of the polyester resin and the vinyl-based resin, and may contain both the polyester resin and the vinyl-based resin or may contain only one of the polyester resin or the vinyl-based resin. In a case where the toner particles contain both the polyester resin and the vinyl-based resin, the toner particles may contain both the polyester resin and the vinyl-based resin as a binder resin, or may contain one of the polyester resin or the vinyl-based resin as a binder resin and the other as resin particles. In a case where the toner particles contain one of the polyester resin or the vinyl-based resin as resin particles, the resin particles may have a crosslinked structure.

In a case where the toner particles contain both the polyester resin and the vinyl-based resin, a mass ratio C of the polyester resin to the vinyl-based resin is, for example, 0.7 or more and 10 or less, and may be 2 or more and 6 or less, or 3 or more and 5 or less.

Examples of the resin containing both the polyester resin and the vinyl-based resin include a resin in which the styrene acrylic resin and the polyester resin coexist.

Here, the coexistence of the styrene acrylic resin and the polyester resin can be achieved not only by mixing the respective resins but also by a chemically bonded hybrid resin (so-called styrene acrylic-modified polyester resin) having a styrene acrylic resin segment and a polyester resin segment. Specifically, a hybrid resin can be obtained by using a polyester monomer having an unsaturated structure, such as fumaric acid and succinic acid, or a resin including a monomer structure thereof as a prepolymer, and polymerizing the prepolymer with a vinyl monomer, such as styrene and acrylic.

In a case where the hybrid resin (so-called styrene acrylic-modified polyester resin) is applied, the mass ratio C of the polyester resin to the vinyl-based resin is measured and calculated as a mass ratio of the polyester segment to the vinyl-based resin segment (for example, the styrene-acrylic resin segment) in the hybrid resin. In a case where the hybrid resin, the vinyl-based resin (for example, the styrene acrylic resin), and the polyester resin are used in combination, the mass ratio C of the polyester resin to the vinyl-based resin is measured and calculated as a mass ratio of the sum of the polyester resin segment in the hybrid resin and the polyester resin to the sum of the vinyl-based resin segment in the hybrid resin and the vinyl-based resin.

A content of the resin with respect to the total amount of the toner particles is, for example, preferably 40% by mass or more and 95% by mass or less, more preferably 50% by mass or more and 90% by mass or less, and still more preferably 60% by mass or more and 88% by mass or less.

### Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye.

One kind of colorant may be used alone, or two or more kinds of colorants may be used in combination.

As the colorant, a colorant having undergone a surface treatment as necessary may be used, or a dispersant may be used in combination with the colorant. Furthermore, a plurality of kinds of colorants may be used in combination.

The content of the colorant with respect to the total amount of the toner particles is, for example, preferably 1% by mass or more and 30% by mass or less, and more preferably 3% by mass or more and 15% by mass or less.

### Release Agent

Examples of the release agent include hydrocarbon-based wax; natural wax such as carnauba wax, rice wax, and candelilla wax; synthetic or mineral petroleum-based wax such as montan wax; and ester-based wax such as fatty acid esters and montanic acid esters. The release agent is not limited to the agents. As the release agent, for example, an ester-based wax or a hydrocarbon-based wax is preferable, and a hydrocarbon-based wax is more preferable.

The melting temperature of the release agent is, for example, preferably 50° C. or higher and 110° C. or lower, and more preferably 60° C. or higher and 105° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

The content of the release agent with respect to the total amount of the toner particles is, for example, preferably 1% by mass or more and 20% by mass or less, and more preferably 4% by mass or more and 15% by mass or less.

### Other Additives

Examples of other additives include well-known additives such as a magnetic material, a charge control agent, and inorganic powder. The additives are incorporated into the toner particles as internal additives.

### Characteristics of Toner Particles and the Like

The toner particles may be toner particles that have a single-layer structure or toner particles having a so-called core/shell structure that is configured with a core portion (core particle) and a coating layer (shell layer) coating the core portion.

Here, the toner particles having a core/shell structure may, for example, be configured with a core portion that is configured with a binder resin and other additives used as necessary, such as a colorant and a release agent, and a coating layer that is configured with a binder resin.

### External Additive

Examples of the external additive include inorganic particles. Examples of the inorganic particles include SiO₂, TiO₂, Al₂O₃, SrTiO₃, CuO, ZnO, SnO₂, CeO₂, Fe₂O₃, MgO, BaO, CaO, K₂O, Na₂O, ZrO₂, CaO·SiO₂, K₂O·(TiO₂) n, Al₂O₃·2SiO₂, CaCO₃, MgCO₃, BaSO₄, and MgSO₄.

The surface of the inorganic particles as an external additive may have undergone, for example, a hydrophobic treatment. The hydrophobic treatment is performed, for example, by dipping the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

Usually, the amount of the hydrophobic agent is, for example, 1 part by mass or more and 10 parts by mass or less with respect to 100 parts by mass of the inorganic particles.

Examples of the external additive also include resin particles (resin particles such as polystyrene, polymethylmethacrylate (PMMA), and melamine resins), a cleaning activator (for example, and a metal salt of a higher fatty acid represented by zinc stearate or fluorine-based polymer particles).

The amount of the external additive externally added with respect to the toner particles is, for example, preferably 0.01% by mass or more and 10% by mass or less, and more preferably 0.01% by mass or more and 6.0% by mass or less.

### Manufacturing Method of Toner

Next, the manufacturing method of the toner according to the present exemplary embodiment will be described.

The toner according to the present exemplary embodiment is obtained by manufacturing toner particles and then externally adding external additives to the toner particles.

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). The manufacturing method of the toner particles is not particularly limited to these manufacturing methods, and a well-known manufacturing method is adopted.

Among the above methods, for example, the aggregation and coalescence method may be used for obtaining toner particles.

Specifically, in a case where the toner particles are manufactured by an aggregation and coalescence method, for example, the toner particles are manufactured through a step (first aggregated particle-forming step) of forming first aggregated particles by mixing a first resin particle dispersion in which first resin particles as a binder resin are dispersed, a colorant dispersion in which a colorant is dispersed, and a release agent particle dispersion in which particles of a release agent (hereinafter, also referred to as “release agent particles”) are dispersed, and aggregating the particles and the colorant in the obtained dispersion; a step (second aggregated particle-forming step) of forming second aggregated particles by, after obtaining the first aggregated particle dispersion in which the first aggregated particles are dispersed, adding second resin particles as a binder resin to the first aggregated particle dispersion, and aggregating the second resin particles on a surface of the first aggregated particles; and a step (coalescence step) of heating the second aggregated particle dispersion in which the second aggregated particles are dispersed to allow the second aggregated particles to undergo coalescence and to form toner particles.

The present aggregation and coalescence method will be described as a method for producing toner particles containing a binder resin, a colorant, and a release agent; but the colorant and the release agent are components to be contained in the toner particles as necessary.

In the aggregation and coalescence method, the low circularity proportion and the high circularity proportion may be controlled by adjusting an amount of an acid added in a coalescence step, a stirring speed at the time of adding the acid, a retention time, and the like.

In addition, the halogen amount may be controlled by adding a halogen-containing compound and adjusting the amount of the halogen-containing compound added. In a case where the halogen-containing compound is added in order to control the halogen amount in the aggregation and coalescence method, the addition of the halogen-containing compound may be carried out, for example, at a timing after the second aggregated particle-forming step and before the coalescence step. The timing of adding the halogen-containing compound is not limited thereto, and may be added in a resin particle dispersion-preparing step, an aggregated particle-forming step, or the coalescence step.

Hereinafter, each of the steps will be specifically described.

### Each Dispersion Preparing Step

First, each dispersion to be used in the aggregation and coalescence method is prepared. Specifically, a first resin particle dispersion in which first resin particles as a binder resin are dispersed, a colorant dispersion in which a colorant is dispersed, a second resin particle dispersion in which second resin particles as a binder resin are dispersed, and a release agent particle dispersion in which release agent particles are dispersed are respectively prepared.

In each dispersion preparing step, the first resin particles and the second resin particles will be referred to as “resin particles” in the following description.

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, an anionic surfactant and a cationic surfactant are particularly mentioned. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing the resin particles in the dispersion medium include general dispersion methods such as a rotary shearing homogenizer, a ball mill having media, a sand mill, and a dyno mill. Depending on the type of resin particles, the resin particles may be dispersed in the resin particle dispersion by using, for example, a transitional phase inversion emulsification method.

The transitional phase inversion emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes conversion (so-called phase inversion) from W/O to O/W, turns into a discontinuous phase, and is dispersed in the aqueous medium in the form of particles.

The volume-average particle size of the resin particles dispersed in the resin particle dispersion is, for example, preferably 0.01 μm or more and 1 μm or less, more preferably 0.08 μm or more and 0.8 μm or less, and still more preferably 0.1 μm or more and 0.6 μm or less.

For determining the volume-average particle size of the resin particles, a particle size distribution is measured using a laser diffraction type particle size distribution analyzer (for example, LA-700 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

For example, a colorant dispersion and a release agent particle dispersion are prepared in the same manner as that adopted for preparing the resin particle dispersion. That is, the volume-average particle size of the particles, the dispersion medium, the dispersion method, and the content of the particles in the resin particle dispersion are also applied to the colorant to be dispersed in the colorant dispersion and the release agent particles to be dispersed in the release agent particle dispersion.

### First Aggregated Particle-Forming Step

Next, the first resin particle dispersion is mixed with the colorant dispersion and the release agent particle dispersion.

In the mixed dispersion, the first resin particles, the colorant, and the release agent particles are hetero-aggregated to form the first aggregated particles including the first resin particles, the colorant, and the release agent particles.

Specifically, for example, an aggregating agent is added to a dispersion obtained by mixing the first resin particle dispersion, the colorant dispersion, and the release agent particle dispersion; the pH of the mixed dispersion is adjusted to acidic (for example, pH of 2 or more and 5 or less); a dispersion stabilizer is added thereto as necessary; the temperature is set to a temperature region of 20° C. or higher and 50° C. or lower; and the particles dispersed in the mixed dispersion are aggregated to form the first aggregated particles.

In the first aggregated particle-forming step, for example, in a state where the mixed dispersion is stirred with a rotary shearing homogenizer, the aggregating agent may be added thereto at room temperature (for example, 25° C.), the pH of the mixed dispersion may be adjusted such that the dispersion is acidic (for example, pH of 2 or higher and 5 or lower), a dispersion stabilizer may be added to the dispersion as necessary, and then the dispersion may be heated.

Examples of the aggregating agent include a surfactant having polarity opposite to the polarity of the surfactant used as a dispersant added to the mixed dispersion, an inorganic metal salt, and a metal complex having a valency of 2 or higher. In particular, in a case where a metal complex is used as the aggregating agent, the amount of the surfactant used is reduced, and the charging characteristics are improved.

An additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may also be used. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added with respect to 100 parts by mass of the first resin particles is, for example, preferably 0.01 parts by mass or more and 5.0 parts by mass or less, and more preferably 0.1 parts by mass or more and less than 3.0 parts by mass.

### Second Aggregated Particle-Forming Step

Next, after obtaining the first aggregated particle dispersion in which the first aggregated particles are dispersed, a second resin particle dispersion in which second resin particles are dispersed is added to the first aggregated particle dispersion.

The second resin particles may be of the same type as the first resin particles, or may be of different types.

Next, the second resin particles are aggregated on the surface of the first aggregated particles in the dispersion of the first aggregated particles and the second resin particles. In this case, by adding the release agent particle dispersion, the second resin particles and the release agent particles may be aggregated on the surface of the first aggregated particles. Specifically, for example, in the first aggregated particle-forming step, in a case where the first aggregated particles reach a target particle size, the second resin particle dispersion is added to the first aggregated particle dispersion, and the mixture is heated at a temperature equal to or lower than the glass transition temperature of the second resin particles.

By setting the pH of the dispersion in a range of, for example, about 6.5 or more and 8.5 or less, the progress of aggregation is stopped.

In this way, the second aggregated particles are obtained in which the second resin particles are aggregated so as to adhere to the surface of the first aggregated particles.

After the second aggregated particle-forming step and before the coalescence step described later, the halogen-containing compound may be added as necessary. The halogen amount and the abundant amount of each halogen element, such as the bromine amount, the chlorine amount, and the iodine amount, in the toner may be controlled by adjusting the type and amount of the halogen-containing compound added.

The halogen-containing compound may be directly added, or may be added in a form of an aqueous solution of the halogen-containing compound. In a case where the aqueous solution of the halogen-containing compound is used, a concentration of the halogen-containing compound with respect to the entire aqueous solution is not particularly limited, and examples thereof include a range of 2% by mass or more and 8% by mass or less.

### Coalescence Step

Next, the second aggregated particle dispersion in which the second aggregated particles are dispersed is heated to, for example, a temperature equal to or higher than the glass transition temperatures of the first and second resin particles (for example, a temperature higher than the glass transition temperatures of the first and second resin particles by 10° C. to 30° C.) such that the second aggregated particles coalesce, thereby forming toner particles.

In the coalescence step, an acid may be added for the purpose of promoting the coalescence of the second aggregated particles. Examples of the type of acid to be added include acid aqueous solutions such as a nitric acid aqueous solution, a nitric acid aqueous solution containing a surfactant, and a formic acid aqueous solution. Examples of the surfactant contained in the nitric acid aqueous solution containing a surfactant include the same surfactants as the surfactant used for preparing the resin particle dispersion described above. A concentration of the acid aqueous solution is not particularly limited, and examples thereof include a range of 0.1 N or more and 0.4 N or less.

The addition of the acid in the coalescence step may be performed only once or may be performed a plurality of times. By adding the acid in a plurality of times, the formation of coarse powder that is likely to be formed in a case where a large amount of acid is added at once is suppressed.

In the coalescence step, the second aggregated particle dispersion may be stirred.

In a case where the second aggregated particle dispersion is stirred and the acid is added in the coalescence step, the stirring speed may be adjusted to control the low circularity proportion and the high circularity proportion, for example, by applying an intermittent cycle of repeating stirring for a certain time and then stopping the stirring. Specifically, for example, a cycle in which the stirring is stopped for a certain period of time at the time of adding the acid and then restarted may be performed in a plurality of times.

By stopping the stirring for a certain period of time at the time of adding the acid, the distribution of the acid is uneven, and the coalescence of the second aggregated particles present in a region where the acid is locally concentrated is promoted, and the coalescence of the second aggregated particles present in a region where the acid is locally diluted is less likely to proceed. Therefore, it is considered that both the toner particles having a high circularity due to the promotion of the coalescence and the toner particles having a low circularity due to the suppression of the progress of the coalescence are generated, and thus both the low circularity proportion and the high circularity proportion are easily controlled within the above-described ranges. Examples of the stirring stop time include a range of 15 seconds or more and 60 seconds or less.

In a case where the acid is added in the coalescence step, the low circularity proportion and the high circularity proportion may be controlled by adjusting the amount of the acid added. It is considered that, as the amount of the acid added is larger, the toner particles having a high circularity are more generated. Examples of the amount of the acid added include a range of 0.035 mol or more and 0.058 mol or less with respect to 100 g of the second aggregated particles, and from the viewpoint of controlling the low circularity proportion and the high circularity proportion within the above-described ranges, the amount of the acid added is, for example, preferably in a range of 0.040 mol or more and 0.052 mol or less.

In a case where the acid is added in a plurality of portions in the coalescence step, the above-described amount of the acid added means the total amount of the acid added in the plurality of portions.

In the coalescence step, the low circularity proportion and the high circularity proportion may be controlled by adjusting a time for which the state of being heated to the temperature equal to or higher than the glass transition temperature of the resin particles is maintained (hereinafter, also referred to as “coalescence time”).

It is considered that, in the coalescence step, the resin is easily moved by maintaining the temperature at or above the glass transition temperature of the resin particles, and thus the toner particles are substantially spherical with time. Therefore, it is considered that, as the coalescence time is longer, the toner particles having a high circularity are more generated.

Examples of the coalescence time include a range of 105 minutes or more and 210 minutes or less, and from the viewpoint of controlling the low circularity proportion and the high circularity proportion within the above-described ranges, the coalescence time is, for example, preferably in a range of 120 minutes or more and 180 minutes or less.

The toner particles are obtained through the above steps.

In the aggregation and coalescence method described above, the first aggregated particles may be coalesced to form the toner particles without performing the second aggregated particle-forming step. In addition, the second aggregated particle-forming step may be repeated a plurality of times.

After the coalescence step, the toner particles formed in a solution undergo a known washing step, solid-liquid separation step, and drying step, thereby obtaining dry toner particles.

The washing step is not particularly limited. However, in view of charging properties, displacement washing may be thoroughly performed using deionized water. The solid-liquid separation step is not particularly limited. However, in view of productivity, suction filtration, pressure filtration, or the like may be performed. Furthermore, the method of the drying step is not particularly limited. However, in view of productivity, freeze drying, flush drying, fluidized drying, vibratory fluidized drying, or the like may be performed.

For example, by adding an external additive to the obtained dry toner particles and mixing the external additive and the toner particles together, the toner according to the present exemplary embodiment is manufactured. The mixing may be performed, for example, using a V blender, a Henschel mixer, a Lödige mixer, or the like. Furthermore, coarse particles of the toner may be removed as necessary by using a vibratory sieving machine, a pneumatic sieving machine, or the like.

### Electrostatic Charge Image Developer

The electrostatic charge image developer according to the present exemplary embodiment contains at least the toner according to the present exemplary embodiment.

The electrostatic charge image developer according to the present exemplary embodiment may be a one-component developer that contains only the toner according to the present exemplary embodiment or a two-component developer that is obtained by mixing the toner and a carrier together.

The carrier is not particularly limited, and examples thereof include known carriers. Examples of the carrier include a coated carrier obtained by coating the surface of a core material consisting of magnetic powder with a coating resin; a magnetic powder dispersion-type carrier obtained by dispersing magnetic powder in a matrix resin and mixing the powder and the resin together; and a resin impregnation-type carrier obtained by impregnating porous magnetic powder with a resin.

Each of the magnetic powder dispersion-type carrier and the resin impregnation-type carrier may be a carrier obtained by coating a core material, that particles configuring the carrier, with a coating resin.

Examples of the magnetic powder include magnetic metals such as iron, nickel, and cobalt; and magnetic oxides such as ferrite and magnetite.

Examples of the coating resin and the matrix resin include a styrene (meth)acrylic acid resin; polyolefin-based resins such as a polyethylene resin and a polypropylene resin; polyvinyl-based or polyvinylidene-based resins such as polystyrene, a (meth)acrylic resin, polyacrylonitrile, polyvinyl acetate, polyvinyl alcohol, polyvinyl butyral, polyvinyl chloride, polyvinylcarbazole, polyvinyl ether, or polyvinyl ketone; a vinyl chloride vinyl acetate copolymer; a straight silicone resin consisting of an organosiloxane bond or a modified product thereof; a fluororesin such as polytetrafluoroethylene, polyvinyl fluoride, polyvinylidene fluoride, or polychlorotrifluoroethylene; polyester; polyurethane; polycarbonate; an amino resin such as a urea formaldehyde resin; and an epoxy resin.

For example, the coating resin and the matrix resin preferably contain a (meth)acrylic resin, more preferably contain 50% by mass or more of the (meth)acrylic resin with respect to the total mass of the resin, and still more preferably contain 80% by mass or more of the (meth)acrylic resin with respect to the total mass of the resin.

In particular, for example, the coating resin and the matrix resin preferably contain an alicyclic (meth)acrylic resin as the (meth)acrylic resin.

The coating resin and the matrix resin may contain other additives such as conductive particles.

Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a coating resin, for example, by a coating method using a solution for forming a coating layer obtained by dissolving the coating resin and various additives, that are used as necessary, in an appropriate solvent, and the like. The solvent is not particularly limited, and may be selected in consideration of the type of the coating resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and removing solvents.

The mixing ratio (mass ratio) between the toner and the carrier, represented by toner:carrier, in the two-component developer is, for example, preferably 1:100 to 30:100, and more preferably 3:100 to 20:100.

### Image Forming Apparatus and Image Forming Method

The image forming apparatus and image forming method according to the present exemplary embodiment will be described.

The image forming apparatus according to the present exemplary embodiment includes an image holder, a charging device that charges the surface of the image holder, an electrostatic charge image forming device that forms an electrostatic charge image on the charged surface of the image holder, a developing device that contains an electrostatic charge image developer and develops the electrostatic charge image formed on the surface of the image holder as a toner image by using the electrostatic charge image developer, a transfer device that transfers the toner image formed on the surface of the image holder to the surface of a recording medium, and a fixing device that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed that has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning device that cleans the surface of the image holder before charging after the transfer of the toner image; and an apparatus including a charge neutralization device that neutralizes charge by irradiating the surface of the image holder with charge neutralizing light before charging after the transfer of the toner image.

In the case of the intermediate transfer-type apparatus, as the transfer device, for example, a configuration is adopted that has an intermediate transfer member with surface on which the toner image will be transferred, a primary transfer device that performs primary transfer to transfer the toner image formed on the surface of the image holder to the surface of the intermediate transfer member, and a secondary transfer device that performs secondary transfer to transfer the toner image transferred to the surface of the intermediate transfer member to the surface of a recording medium.

In the image forming apparatus according to the present exemplary embodiment, for example, a portion including the developing device may be a cartridge structure (process cartridge) to detachable from the image forming apparatus. As the process cartridge, for example, a process cartridge is suitably used that includes a developing device that contains the electrostatic charge image developer according to the present exemplary embodiment.

An example of the image forming apparatus according to the present exemplary embodiment will be shown below, but the present invention is not limited thereto. Hereinafter, among the parts shown in the drawing, main parts will be described, and others will not be described.

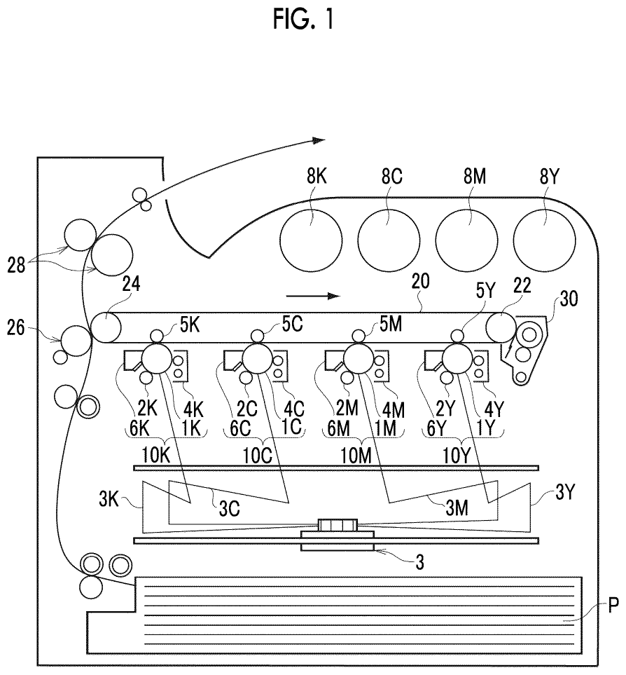

FIG. 1 is a view schematically showing the configuration of the image forming apparatus according to the present exemplary embodiment.

The image forming apparatus shown in FIG. 1 includes first to fourth image forming units 10Y, 10M, 10C, and 10K adopting an electrophotographic method that output images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are attached to and detached from the image forming apparatus.

An intermediate transfer belt 20 as an intermediate transfer member passing through the units 10Y, 10M, 10C, and 10K extends above the units in the drawing. The intermediate transfer belt 20 is looped over a driving roll 22 and a support roll 24 that in contact with the inner surface of the intermediate transfer belt 20, the rolls 22 and 24 being spaced apart in the horizontal direction in the drawing. The intermediate transfer belt 20 is designed to run in a direction toward the fourth unit 10K from the first unit 10Y. Force is applied to the support roll 24 in a direction away from the driving roll 22 by a spring or the like (not shown in the drawing) Tension is applied to the intermediate transfer belt 20 looped over the two rolls. An intermediate transfer member cleaning device 30 facing the driving roll 22 is provided on the outer peripheral surface of the intermediate transfer belt 20.

In addition, a toner including toners having four colors of yellow, magenta, cyan, and black, that are contained in containers of toner cartridges 8Y, 8M, 8C, and 8K, is supplied to developing devices (example of the developing device) 4Y, 4M, 4C, and 4K of the units 10Y, 10M, 10C, and 10K, respectively.

The first to fourth units 10Y, 10M, 10C, and 10K have the same configuration. Therefore, in the present specification, as a representative, the first unit 10Y will be described that placed on the upstream side of the running direction of the intermediate transfer belt and forms a yellow image. Reference numerals marked with magenta (M), cyan (C), and black (K) instead of yellow (Y) are assigned in the same portions as in the first unit 10Y, such that the second to fourth units 10M, 10C, and 10K will not be described again.

The first unit 10Y has a photoreceptor 1Y that acts as an image holder. Around the photoreceptor 1Y, a charging roll (an example of the charging device) 2Y that charges the surface of the photoreceptor 1Y at a predetermined potential, an exposure device (an example of the electrostatic charge image forming device) 3 that exposes the charged surface to a laser beam 3Y based on color-separated image signals to form an electrostatic charge image, a developing device (an example of the developing device) 4Y that develops the electrostatic charge image by supplying a charged toner to the electrostatic charge image, a primary transfer roll (an example of the primary transfer device) 5Y that transfers the developed toner image onto the intermediate transfer belt 20, and a photoreceptor cleaning device (an example of the cleaning device) 6Y that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y. Furthermore, a bias power supply (not shown in the drawing) for applying a primary transfer bias is connected to each of primary transfer rolls 5Y, 5M, 5C, and 5K. Each bias power supply varies the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with the laser beam 3Y, the specific resistance of the portion irradiated with the laser beam changes. Therefore, via an exposure device 3, the laser beam 3Y is output to the surface of the charged photoreceptor 1Y according to the image data for yellow transmitted from the control unit not shown in the drawing. The laser beam 3Y is radiated to the photosensitive layer on the surface of the photoreceptor 1Y. As a result, an electrostatic charge image of a yellow image pattern is formed on the surface of the photoreceptor 1Y.

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y turns into a visible image (developed image) as a toner image by the developing device 4Y.

The developing device 4Y contains, for example, an electrostatic charge image developer that contains at least a yellow toner and a carrier. By being stirred in the developing device 4Y, the yellow toner undergoes triboelectrification, carries charges of the same polarity (negative polarity) as the charges with which the surface of the photoreceptor 1Y is charged, and is held on a developer roll (an example of a developer holder). As the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. For example, in the first unit 10Y, the transfer bias is set to +10 μA under the control of the control unit (not shown in the drawing).

On the other hand, the residual toner on the photoreceptor 1Y is removed by a photoreceptor cleaning device 6Y and collected.

In addition, the primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superimposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt, and a secondary transfer roll (an example of the secondary transfer device) 26 disposed on the outer peripheral surface of the intermediate transfer belt 20. On the other hand, via a supply mechanism, recording paper P (an example of recording medium) is supplied at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, that makes the toner image on the intermediate transfer belt 20 transferred onto the recording paper P. The secondary transfer bias to be applied at this time is determined according to the resistance detected by a resistance detecting device (not shown in the drawing) for detecting the resistance of the secondary transfer portion, and the voltage thereof is controlled.

Thereafter, the recording paper P is transported into a pressure contact portion (nip portion) of a pair of fixing rolls in the fixing device 28 (an example of the fixing device), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is preferable that the surface of the recording paper P is also smooth. For example, coated paper prepared by coating the surface of plain paper with a resin or the like, art paper for printing, and the like are suitably used.

The recording paper P on which the colored image has been fixed is transported to an output portion, and a series of colored image forming operations is finished.

### Process Cartridge and Toner Cartridge

The process cartridge according to the present exemplary embodiment will be described.

The process cartridge according to the present exemplary embodiment includes a developing device that contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing device and, for example, at least one member selected from other devices, such as an image holder, a charging device, an electrostatic charge image forming device, and a transfer device, as necessary.

An example of the process cartridge according to the present exemplary embodiment will be shown below, but the present invention is not limited thereto. Hereinafter, among the parts shown in the drawing, main parts will be described, and others will not be described.

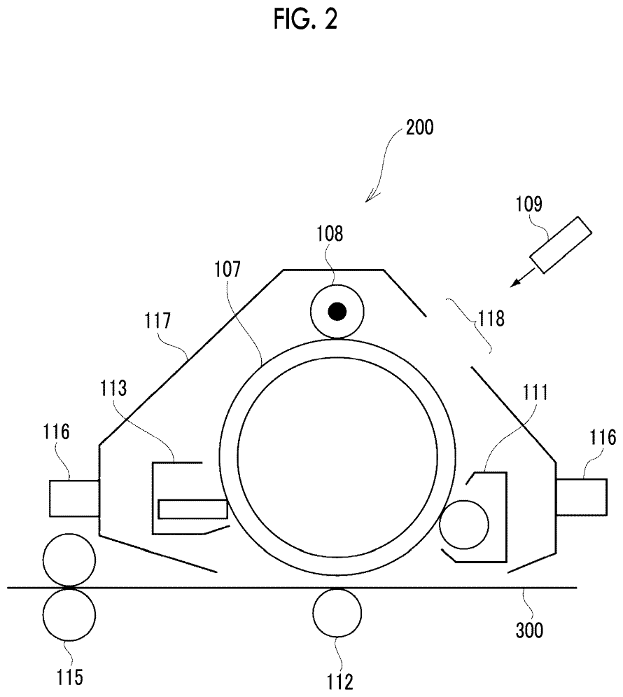

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging device) that is provided on the periphery of the photoreceptor 107, a developing device 111 (an example of developing device), a photoreceptor cleaning device 113 (an example of cleaning device), that are integrally combined and held in the housing 117. The process cartridge 200 forms a cartridge in this way.

In FIG. 2, 109 represents an exposure device (an example of electrostatic charge image forming device), 112 represents a transfer device (an example of transfer device), 115 represents a fixing device (an example of fixing device), and 300 represents recording paper (an example of recording medium).

Next, the toner cartridge according to the present exemplary embodiment will be described.

The toner cartridge according to the present exemplary embodiment is a toner cartridge including a container that contains the toner according to the present exemplary embodiment and is detachable from the image forming apparatus. The toner cartridge includes a container that contains a replenishing toner to be supplied to the developing device provided in the image forming apparatus.

The image forming apparatus shown in FIG. 1 is an image forming apparatus having a configuration that enables toner cartridges 8Y, 8M, 8C, and 8K to be detachable from the apparatus. The developing devices 4Y, 4M, 4C, and 4K are connected to toner cartridges corresponding to the respective developing devices (colors) by a toner supply pipe not shown in the drawing. In addition, in a case where the amount of the toner contained in the container of the toner cartridge is low, the toner cartridge is replaced.

### EXAMPLES

Hereinafter, exemplary embodiments of the present invention will be specifically described based on Examples. However, the exemplary embodiments of the present invention are not limited to Examples. In the following description, unless otherwise specified, “parts” and “%” are based on mass.

### Production of Various Dispersions

### Preparation of Amorphous Polyester Resin

First, the following monomers are prepared in order to prepare an amorphous polyester resin.
Ethylene oxide (2.2 mol) adduct of bisphenol A: 230 parts by mass
Propylene oxide (2.2 mol) adduct of bisphenol A: 367 parts by mass
Dimethyl terephthalate: 163 parts by mass
Dimethyl fumarate: 12 parts by mass
Dodecenyl succinic acid anhydride: 227 parts by mass
Trimellitic acid anhydride: 20 parts by mass

Next, the ethylene oxide (2.2 mol) adduct of bisphenol A, the propylene oxide (2.2 mol) adduct of bisphenol A, the dimethyl terephthalate, and the dodecenyl succinic acid anhydride are put in a container, and 2.55 parts by mass of tin dioctanoate is put in the container. Subsequently, the sample charged at 235° C. is reacted for 6 hours in a nitrogen gas stream, and then the dimethyl fumarate and the trimellitic acid anhydride are charged and reacted at 200° C. for 1 hour. Furthermore, the temperature is raised to 220° C. over 5 hours, and the monomers are polymerized under a pressure of 10 kPa to obtain a transparent light yellow amorphous polyester resin.

The prepared amorphous polyester resin has a weight-average molecular weight (Mw) of 35,000, a number-average molecular weight (Mn) of 8,000, and a glass transition temperature (Tg) of 59° C.

### Preparation of Crystalline Polyester Resin

First, the following monomers are prepared in order to prepare a crystalline polyester resin.
1,10-Dodecanedioic acid: 225 parts by mass
1,6-Hexanediol: 118 parts by mass

Next, the above-described two monomers are put in a container, the air in the container is replaced with dried nitrogen gas, and 0.86 parts by mass of titanium tetrabutoxide is added thereto. Subsequently, the mixture is stirred at 170° C. for 3 hours in a nitrogen gas stream. Furthermore, the temperature is raised to 210° C. over 1 hour, the inside of the container is depressurized to 3 kPa, and the mixture is stirred for 13 hours, thereby obtaining a crystalline polyester resin.

The prepared crystalline polyester resin has a weight-average molecular weight (Mw) of 25,000, a number-average molecular weight (Mn) of 10,500, an acid value of 10.1 mgKOH/g, and a melting temperature of 73.6° C. calculated by DSC.

### Preparation of Amorphous Polyester Resin Particle Dispersion

100 parts by mass of the above-described amorphous polyester resin is put into a disperser obtained by improving CAVITRON CD1010 manufactured by Eurotech Ltd. to a high-temperature and high-pressure type.

Next, deionized water is added thereto until a mass percent concentration of the sample added to the disperser reaches 1/5, the pH is adjusted to 8.5 using ammonia, and the disperser is operated under conditions of a rotation speed of a rotor of 60 Hz, a pressure of 5 kg/cm², and a temperature of 140° C. to prepare a prepared liquid.

A volume-average particle size of the resin particles in the prepared liquid is 130 nm. Deionized water is added to the prepared liquid such that the solid content reaches 20% by mass, thereby obtaining an amorphous polyester resin particle dispersion in which particles of the amorphous polyester resin as a binder resin are dispersed.

### Preparation of Crystalline Polyester Resin Particle Dispersion

A crystalline polyester resin particle dispersion in which particles of the crystalline polyester resin as a binder resin are dispersed is prepared by the same method as the method for preparing the amorphous polyester resin particle dispersion, except that a crystalline polyester resin is used in an amount of 100 parts by mass, instead of the amorphous polyester resin. A volume-average particle size of the resin particles in the obtained crystalline polyester resin particle dispersion is 130 nm, and the solid content is set to 20% by mass.

### Production of Styrene Acrylic Resin Particle Dispersion

Styrene: 375 parts by mass
n-Butyl acrylate: 25 parts by mass
Acrylic acid: 2 parts by mass
Dodecanethiol: 24 parts by mass
Carbon tetrabromide: 4 parts by mass

A mixture obtained by mixing and dissolving the above-described materials is dispersed and emulsified in a surfactant solution obtained by dissolving 6 parts by mass of a nonionic surfactant (manufactured by Sanyo Chemical Industries, Ltd., NONIPOL 400) and 10 parts by mass of an anionic surfactant (Tayca Power, manufactured by Tayca Co., Ltd., solid content: 12% by mass, sodium dodecylbenzenesulfonate) in 550 parts by mass of deionized water in a flask. Next, the mixture in the flask is stirred, and in this state, an aqueous solution obtained by dissolving 4 parts by mass of ammonium persulfate in 50 parts by mass of deionized water is added thereto for 20 minutes. Next, nitrogen purging is performed, and in a state in which the mixture in the flask is stirred, the flask is heated in an oil bath until the temperature of the content reaches 70° C., and the temperature is kept at 70° C. for 5 hours so that emulsion polymerization continues. In this way, a resin particle dispersion in which resin particles having a volume-average particle size of 150 nm, a weight-average molecular weight (Mw) of 33,000, and a glass transition temperature (Tg) of 63° C. are dispersed is obtained. Deionized water is added to the resin particle dispersion such that the solid content thereof is adjusted to 20% by mass, thereby obtaining a styrene acrylic resin particle dispersion in which particles of the styrene acrylic resin as a binder resin are dispersed.

### Production of Styrene Acrylic-Modified Polyester Resin Particle Dispersion

The inside of a four-neck flask provided with a nitrogen introduction tube, a dehydration tube, a stirrer, and a thermocouple is substituted with nitrogen, 5,670 parts by mass of polyoxypropylene (2.2)-2,2-bis(4-hydroxyphenyl) propane, 585 parts by mass of polyoxyethylene (2.0)-2,2-bis(4-hydroxyphenyl) propane, 2,450 parts by mass of terephthalic acid, and 44 parts by mass of tin (II) di(2-ethylhexanoate) are added to the flask, the mixture is stirred in a nitrogen atmosphere, heated to 235° C., and maintained at the same temperature for 5 hours, and the pressure inside the flask is further reduced and maintained at 8.0 kPa for 1 hour. After the pressure is returned to the atmospheric pressure, the mixture is cooled to 190° C., 42 parts by mass of fumaric acid and 207 parts by mass of trimellitic acid are added thereto, and the mixture is maintained at a temperature of 190° C. for 2 hours and heated to 210° C. for 2 hours. Furthermore, the pressure in the flask is reduced and maintained at 8.0 kPa for 4 hours, thereby obtaining an amorphous polyester resin A (polyester segment).

Next, 800 parts by mass of the amorphous polyester resin A is added to a four-neck flask provided with a cooling tube, a stirrer, and a thermocouple, and the mixture is stirred at a stirring speed of 200 rpm in a nitrogen atmosphere. Thereafter, 100 parts by mass of styrene, 82 parts by mass of ethyl acrylate, 16 parts by mass of acrylic acid, 2 parts by mass of 1,10-decanediol diacrylate, and 100 parts by mass of toluene are added thereto as addition-polymerizable monomers, and the mixture is further mixed for 30 minutes.

Furthermore, 6 parts by mass of polyoxyethylene alkyl ether (nonionic surfactant, trade name: EMULGEN 430, manufactured by Kao Corporation), 40 parts by mass of a 15% by mass sodium dodecylbenzenesulfonate aqueous solution (anionic surfactant, trade name: NEOPELEX G-15, manufactured by Kao Corporation), and 233 parts by mass of 5% by mass potassium hydroxide are added thereto, and the mixture is heated to 95° C. so as to be melted while being stirred and mixed at 95° C. for 2 hours, thereby obtaining a resin mixture solution.

Next, 1,145 parts by mass of deionized water is added dropwise to the resin mixture solution at a rate of 6 parts by mass/min while the resin mixture solution is stirred, thereby obtaining an emulsion. Next, the obtained emulsion is cooled to 25° C., passed through a 200-mesh metal net, and deionized water is added thereto so that the solid content is adjusted to 20% by mass, thereby obtaining a styrene acrylic-modified polyester resin particle dispersion in which particles of the styrene acrylic-modified polyester resin as a binder resin are dispersed.

In the synthesized styrene acrylic-modified polyester resin, “mass ratio of a styrene-acrylic resin segment and a polyester resin segment (styrene-acrylic resin segment/polyester resin segment)” is 20/80, the glass transition temperature (Tg) is 56° C., and the weight-average molecular weight (Mw) is 33,000.

### Preparation of Black Pigment Dispersion

First, the following samples are prepared in order to prepare a black pigment dispersion that an example of a colorant dispersion.
Carbon black (Regel 330 manufactured by Cabot Corporation.): 250 parts by mass
Anionic surfactant (NEOGEN (registered trademark) SC manufactured by DKS Co., Ltd.): 33 parts by mass
Deionized water: 750 parts by mass

Next, 280 parts by mass of deionized water and 33 parts by mass of the anionic surfactant are put in a container. After dissolving the surfactant, 250 parts by mass of the carbon black (Regal 330) is put in the container, and the mixture is stirred and defoamed using a stirrer until there is no non-wetted pigment. After the defoaming, the remaining deionized water is added thereto, and the mixture is stirred at 5,000 rpm for 10 minutes using a homogenizer (ULTRA-TURRAX (registered trademark) T50 manufactured by IKA Japan Co., Ltd.) to disperse the carbon black (Regal 330), and then the mixture is stirred and defoamed with a stirrer for 1 day. After the defoaming, the carbon black (Regal 330) is dispersed by stirring at 6,000 rpm for 10 minutes using a homogenizer (ULTRA-TURRAX T50), and then stirred for 1 day using a stirrer to be defoamed.

Subsequently, the carbon black (Regal 330) is dispersed in the mixture using a high-pressure impact disperser ULTIMAIZER (HJP30006 manufactured by SUGINO MACHINE LIMITED) at a pressure of 240 MPa to obtain a mixed solution. The obtained mixed solution is allowed to stand for 72 hours to remove the precipitate, and deionized water is added thereto, thereby obtaining a black pigment dispersion adjusted to have a concentration of solid contents of 15% by mass.

A volume-average particle size of the particles in the obtained black pigment dispersion is 135 nm.

### Preparation of Release Agent Particle Dispersion

First, the following samples are prepared in order to prepare a release agent particle dispersion.
Polyethylene-based wax (hydrocarbon-based wax, Polywax (registered trademark) 725 manufactured by Baker Petrolite Corporation, melting temperature: 104° C.): 270 parts by mass
Anionic surfactant (NEOGEN RK manufactured by DKS Co., Ltd.): 13.5 parts by mass
Deionized water: 21.6 parts by mass

Next, the above-described three samples are mixed together, the polyethylene-based wax (Polywax 725) is dissolved using a pressure-type homogenizer (Gaulin homogenizer manufactured by Gaulin Corporation), and the dispersion treatment of the polyethylene-based wax (Polywax 725) is performed at a pressure of 5 MPa for 120 minutes and further at a pressure of 40 MPa for 360 minutes, thereby obtaining a mixed solution. The obtained mixed solution is cooled, and deionized water is added thereto to obtain a release agent particle dispersion in which a concentration of solid contents is adjusted to 20.0% by mass.

A volume-average particle size of the particles in the obtained release agent particle dispersion is 225 nm.

### Preparation of Halogen Aqueous Solution Br

31 parts by mass of dodecyltrimethylammonium bromide (molecular weight: 308) as a bromine-containing compound and 500 parts by mass of deionized water are mixed and dissolved, thereby preparing a halogen aqueous solution Br.

### Preparation of Halogen Aqueous Solution Cl

26 parts by mass of dodecyltrimethylammonium chloride (molecular weight: 263) as a chlorine-containing compound and 500 parts by mass of deionized water are mixed and dissolved, thereby preparing a halogen aqueous solution Cl.

### Preparation of Halogen Aqueous Solution I

36 parts by mass of dodecyltrimethylammonium iodide (molecular weight: 355) as an iodine-containing compound and 500 parts by mass of deionized water are mixed and dissolved, thereby preparing a halogen aqueous solution I.

### Preparation of Halogen Aqueous Solution F

15 parts by mass of sodium monofluorophosphate (molecular weight: 144) as a compound containing fluorine and 500 parts by mass of deionized water are mixed and dissolved, thereby preparing a halogen aqueous solution F.

### Production of Toner

### Production of Toner 1

Amorphous polyester resin particle dispersion: 950 parts by mass
Crystalline polyester resin particle dispersion: 300 parts by mass
Black pigment dispersion: 160 parts by mass
Release agent particle dispersion: 60 parts by mass
Deionized water: 600 parts by mass
Anionic surfactant (Dowfax (registered trademark) 2A1 manufactured by Dow Chemical Company): 2.9 parts by mass

The above-described components are charged into a 3-liter reaction container equipped with a thermometer, a pH meter, and a motor type stirring blade, a heater bus is installed outside, and the temperature is adjusted with ice and the heater to maintain the temperature at 25° C.

Subsequently, 1.0% by mass of nitric acid is added thereto to adjust the pH to 3.0, 130 parts by mass of an aqueous solution of aluminum sulfate adjusted to a concentration of 2.0% by mass is added thereto, and the mixture is dispersed for 6 minutes while being dispersed at 5,000 rpm with a homogenizer (manufactured by IKA Japan Co., Ltd.; ULTRA-TURRAX T50).

Thereafter, the temperature of the reaction container is raised to 40° C. at a temperature rising rate of 0.2° C./min and raised at a temperature rising rate of 0.05° C./min after 40° C. while stirring at a stirring speed of 100 rpm using a stirring blade provided in the reaction container instead of the homogenizer, and the particle size is measured by Multi-sizer II (aperture size: 50 μm, manufactured by Beckman Coulter, Inc.) every 10 minutes. The temperature is maintained at this point where the volume-average particle size exceeds 5.0 μm, 50 parts by mass of the amorphous polyester resin dispersion is added thereto for 5 minutes, and the mixture is maintained at 50° C. for 30 minutes while being stirred at 100 rpm (second aggregated particle-forming step).

After the end of the second aggregated particle-forming step, the stirring speed of the stirring blade is set to 100 rpm for continuous operation, 50 parts by mass of a 10% by mass aqueous solution of CHELEST 70 (manufactured by CHELEST CORPORATION) as a chelating agent is added dropwise thereto, 60 parts by mass of the halogen aqueous solution Br is added dropwise, and the pH is adjusted to 9.0 using a 1.0% by mass sodium hydroxide aqueous solution. Thereafter, the temperature is raised to 90° C. at a temperature rising rate of 1° C./min while adjusting the pH to 9.0 at every 5° C. in the same manner.

While maintaining the temperature at 90° C., 0.3 M nitric acid aqueous solution is added thereto and the stirring is stopped for 30 seconds at the time when the temperature reaches 90° C. (hereinafter, also referred to as “coalescence start time point”) and every 30 minutes from the coalescence start time point, as shown in Table 1. Specifically, 12 parts by mass of a 0.3 M nitric acid aqueous solution is added thereto and the stirring is stopped for 30 seconds at 0 minutes after the coalescence start time point, and the continuous operation at a stirring speed of 100 rpm is restarted; 12 parts by mass of a 0.3 M nitric acid aqueous solution is added thereto and the stirring is stopped for 30 seconds at 30 minutes after the coalescence start time point, and the continuous operation at a stirring speed of 100 rpm is restarted; 12 parts by mass of a 0.3 M nitric acid aqueous solution is added thereto and the stirring is stopped for 30 seconds at 60 minutes after the coalescence start time point, and the continuous operation at a stirring speed of 100 rpm is restarted; 12 parts by mass of a 0.3 M nitric acid aqueous solution is added thereto and the stirring is stopped for 30 seconds at 90 minutes after the coalescence start time point, and the continuous operation at a stirring speed of 100 rpm is restarted; 9 parts by mass of a 0.3 M nitric acid aqueous solution is added thereto and the stirring is stopped for 30 seconds at 120 minutes after the coalescence start time point, and the continuous operation at a stirring speed of 100 rpm is restarted; and the temperature is maintained at 90° C. until 135 minutes after the coalescence start time point, and the liquid temperature is rapidly cooled to 30° C. via ice water, thereby obtaining a toner slurry liquid (that is, the coalescence time is set to 135 minutes).

The toner slurry liquid after cooling is passed through a nylon mesh having an opening of 15 μm to remove coarse powder and foreign matters, and the toner slurry that has passed through the mesh is vacuum-filtered with an aspirator using Nutsche on which 5A filter paper is placed. The toner cake remaining on the filter paper is taken out into a bucket container, and the mass thereof is measured. An amount of deionized water at 30° C., that is 10 times the mass of the toner cake, is added thereto, and the mixture is stirred for 30 minutes and then filtered off using Nutsche in the same manner. Subsequently, the same operation of loosening the toner cake with 10 times the amount of deionized water and filtering is performed three times to wash the toner. The toner cake after the washing is dried under reduced pressure at 30° C. using a freeze vacuum dryer, and then taken out and loosened well with a spatula to obtain toner particles.

1.5 parts by mass of hydrophobic silica (manufactured by Nippon Aerosil Co., Ltd., RY200S) is added to 100 parts by mass of the obtained toner particles, and the mixture is mixed and blended at 13,000 rpm for 30 seconds using a sample mill. Thereafter, the mixture is sieved using a vibration sieve having an opening of 45 μm, thereby obtaining a toner 1.

### Production of Toner 2 to Toner 18, Toner 21 to Toner 29, and Toner C1 to Toner C5

Toners 2 to 18, 21 to 29, and C1 to C5 are obtained in the same manner as the toner 1, except that a volume-average particle size of the aggregated particles before adding 50 parts by mass of the amorphous polyester resin dispersion in the aggregated particle-forming step (in the tables, “Particle size before addition (μm)”), the kind and amount of the halogen aqueous solution added dropwise, a relationship between the time from the coalescence start time point and the amount of the 0.3 M nitric acid aqueous solution added (in the tables, “Amount of acid added (parts by mass)”), whether or not the stirring is stopped for 30 seconds at the time of adding the 0.3 M nitric acid aqueous solution (in the tables, “Stopped or continuous”), the total amount of the 0.3 M nitric acid aqueous solution added (in the tables, “Total amount added (parts by mass)”), and the coalescence time are as shown in Tables 1 and 2.

In Tables 1 and 2, “-” indicates that the halogen aqueous solution is not added dropwise or the 0.3 M nitric acid aqueous solution is not added, “Stopped” indicates that the stirring is stopped for 30 seconds at the time of adding the 0.3 M nitric acid aqueous solution, and “Continuous” indicates that the solution is continuously stirred without being stopped for 30 seconds at the time of adding the 0.3 M nitric acid aqueous solution.

### Production of Toner 19

Amorphous polyester resin particle dispersion: 950 parts by mass
Crystalline polyester resin particle dispersion: 50 parts by mass
Styrene acrylic resin particle dispersion: 250 parts by mass
Black pigment dispersion: 160 parts by mass
Release agent particle dispersion: 60 parts by mass
Deionized water: 600 parts by mass
Anionic surfactant (Dowfax (registered trademark) 2A1 manufactured by Dow Chemical Company): 2.9 parts by mass

The above-described components are charged into a 3-liter reaction container equipped with a thermometer, a pH meter, and a motor type stirring blade, a heater bus is installed outside, and the temperature is adjusted with ice and the heater to maintain the temperature at 25° C.

While dispersing with a homogenizer (manufactured by IKA Japan Co., Ltd.; ULTRA-TURRAX T50) at 5,000 rpm, 0.05 parts by mass of polyaluminum chloride is added, and the dispersion operation with the homogenizer (ULTRA-TURRAX) is continued.

Thereafter, the temperature of the reaction container is raised to 50° C. while stirring at a stirring speed of 100 rpm using a stirring blade provided in the reaction container instead of the homogenizer, and maintained at 50° C. for 1 hour. Thereafter, the particle size is measured every 10 minutes with Multi-sizer II (aperture size: 50 μm, manufactured by Beckman Coulter, Inc.) at a temperature rising rate of 0.5° C./min, the temperature is maintained at a point in time when the volume-average particle size exceeds 5.0 μm, and 50 parts by mass of the amorphous polyester resin dispersion is added dropwise thereto for 5 minutes, followed by stirring at 100 rpm for 30 minutes in a state of being maintained at 50° C. (second aggregated particle-forming step).

A process after the end of the second aggregated particle-forming step is performed in the same manner as in the toner 1, thereby obtaining a toner 19.

### Production of Toner 20

Styrene acrylic-modified polyester resin particle dispersion: 950 parts by mass
Crystalline polyester resin particle dispersion: 300 parts by mass
Black pigment dispersion: 160 parts by mass
Release agent particle dispersion: 60 parts by mass
Deionized water: 600 parts by mass
Anionic surfactant (Dowfax (registered trademark) 2A1 manufactured by Dow Chemical Company): 2.9 parts by mass

The above-described components are charged into a 3-liter reaction container equipped with a thermometer, a pH meter, and a motor type stirring blade, a heater bus is installed outside, and the temperature is adjusted with ice and the heater to maintain the temperature at 25° C.

While dispersing with a homogenizer (manufactured by IKA Japan Co., Ltd.; ULTRA-TURRAX T50) at 5,000 rpm, 0.05 parts by mass of polyaluminum chloride is added, and the dispersion operation with the homogenizer (ULTRA-TURRAX) is continued.

Thereafter, the temperature of the reaction container is raised to 50° C. while stirring at a stirring speed of 100 rpm using a stirring blade provided in the reaction container instead of the homogenizer, and maintained at 50° C. for 1 hour. Thereafter, the particle size is measured every 10 minutes with Multi-sizer II (aperture size: 50 μm, manufactured by Beckman Coulter, Inc.) at a temperature rising rate of 0.5° C./min, the temperature is maintained at a point in time when the volume-average particle size exceeds 5.0 μm, and 50 parts by mass of the styrene acrylic-modified polyester resin dispersion is added dropwise thereto for 5 minutes, followed by stirring at 100 rpm for 30 minutes in a state of being maintained at 50° C. (second aggregated particle-forming step).

A process after the end of the second aggregated particle-forming step is performed in the same manner as in the toner 1, thereby obtaining a toner 20.

### Measurement and Evaluation of Toner

In the obtained toner, the low circularity proportion, the high circularity proportion, the ratio (low circularity proportion/high circularity proportion) (in the tables, “Ratio (low circularity/high circularity)), the number-average particle size, the proportion of the specific-sized particles (in the tables, “Specific size proportion (% by number)”), the average circularity, the halogen amount, the bromine amount, the chlorine amount, and the iodine amount are shown in Tables 3 to 5, as the results obtained by the methods described above.

In the tables, “-” indicates that the corresponding halogen element is not contained.

In the toner 1 to the toner 29, the existence proportion of particles having a particle size of 4.5 μm or more and 7.5 μm or less and a circularity of 0.990 or more is 4% by number or more and 6% by number or less with respect to the total number of particles of the toner.

### Production of Developer

Each of the toner and a carrier obtained by the method shown below is put in a V blender at a mass ratio (toner/carrier)=5/95, and stirred for 20 minutes, thereby obtaining each developer.

### Production of Carrier

A mixed solution obtained by dispersing and mixing, in 10 parts by mass of toluene, 2.0 parts by mass of a cyclohexyl methacrylate resin (weight-average molecular weight: 150,000), 0.6 parts by mass of carbon black (VXC72), and 0.3 parts by mass of melamine beads (EPOSTAR S) with respect to 100 parts by mass of a ferrite core having a volume-average particle size of 35 μm is used for coating a carrier with a kneader device.

### Evaluation of Transferability

As an evaluation machine printer, a modified machine of “700 Digital Color Press (manufactured by FUJIFILM Business Innovation Corp.)” is used. The developer at each level is filled in the developing machine, and transferability is evaluated.

As a paper (recording medium), plain paper (manufactured by FUJIFILM Business Innovation Corp., A4, C2 paper) is used. The plain paper that has been left to stand in a high-temperature and low-humidity environment (30° C., 20% RH) for 24 hours and then in a high-temperature and high-humidity environment (30° C., 85% RH) for 48 hours is put in a printer tray and used.

The evaluation environment is set to the high-temperature and high-humidity environment (30° C., 85% RH), and after 48 hours of installation of the printer, a solid image of a rectangular shape of 5×10 cm is formed on the above-described plain paper such that the toner application amount is 5 g/m², and then the image quality is evaluated (color loss due to poor transfer is checked). The obtained image is visually checked, and the transferability grade is determined according to the following standard. The results are shown in Tables 3 to 5.

### Evaluation Standard for Transferability

A: color loss is not observed in the image on the plain paper (C2 paper).
B+: color loss is present in a range of 1% or less of the image area on the image of the plain paper (C2 paper).
B: color loss is present in a range of more than 1% and 2% or less of the image area on the image of the plain paper (C2 paper).
C+: color loss is present in a range of more than 2% and 4% or less of the image area on the image of the plain paper (C2 paper).
C: color loss is present in a range of more than 4% and 6% or less of the image area on the image of the plain paper (C2 paper).
D: color loss is present in a range of more than 6% of the image area on the image of the plain paper (C2 paper).

TABLE 1

| | Particle | Halogen aqueous | | | | | | | | | | Total | |
|---|---|---|---|---|---|---|---|---|---|---|---|---|---|
| | size | solution | | | | | | | | | | amount | |
| | before | | Amount | Amount of acid added (part by mass) | | | | | | | | added | |
| | addition | | (part by | 0 | 30 | 60 | 90 | 120 | 150 | 180 | Stopped or | (part by | Coalescence |
| Toner | (μm) | Type | mass) | minutes | minutes | minutes | minutes | minutes | minutes | minutes | continuous | mass) | time (min) |
| 1 | 5.0 | Br | 60 | 12 | 12 | 12 | 12 | 9 | — | — | Stopped | 57 | 135 |
| 2 | 5.0 | Cl | 138 | 12 | 12 | 12 | 12 | 9 | — | — | Stopped | 57 | 135 |
| 3 | 5.0 | Br | 60 | 16 | 12 | 12 | 12 | 5 | — | — | Stopped | 57 | 135 |
| 4 | 5.0 | I | 38 | 12 | 12 | 12 | 12 | 9 | — | — | Stopped | 57 | 135 |
| 5 | 5.0 | Br | 60 | 15 | 12 | 12 | 12 | 6 | — | — | Stopped | 57 | 135 |
| 6 | 5.0 | Br | 60 | 18 | 12 | 12 | 12 | 6 | — | — | Stopped | 60 | 135 |
| 7 | 5.0 | Br | 60 | 12 | 12 | 12 | 12 | — | — | — | Stopped | 48 | 105 |
| 8 | 5.0 | Br | 60 | 12 | 12 | 12 | 6 | 6 | 6 | — | Stopped | 54 | 135 |
| 9 | 5.0 | Br | 60 | 12 | 12 | 12 | 12 | 6 | 6 | — | Stopped | 60 | 180 |
| 10 | 5.0 | Br | 400 | 15 | 12 | 12 | 12 | 6 | — | — | Stopped | 57 | 135 |
| 11 | 5.0 | Br | 440 | 15 | 12 | 12 | 12 | 6 | — | — | Stopped | 57 | 135 |
| 12 | 5.0 | Br | 15 | 15 | 12 | 12 | 12 | 6 | — | — | Stopped | 57 | 135 |
| 13 | 5.0 | Br | 20 | 15 | 12 | 12 | 12 | 6 | — | — | Stopped | 57 | 135 |
| 14 | 5.0 | — | — | 12 | 12 | 12 | 12 | 9 | — | — | Stopped | 57 | 135 |
| 15 | 5.0 | Br | 120 | 15 | 12 | 12 | 12 | 6 | — | — | Stopped | 57 | 135 |
| 16 | 5.0 | Br | 128 | 15 | 12 | 12 | 12 | 6 | — | — | Stopped | 57 | 135 |
| 17 | 5.0 | Br | 40 | 15 | 12 | 12 | 12 | 6 | — | — | Stopped | 57 | 135 |
| 18 | 5.0 | Br | 32 | 15 | 12 | 12 | 12 | 6 | — | — | Stopped | 57 | 135 |
| 19 | 5.0 | Br | 60 | 12 | 12 | 12 | 12 | 9 | — | — | Stopped | 57 | 135 |
| 20 | 5.0 | Br | 60 | 12 | 12 | 12 | 12 | 9 | — | — | Stopped | 57 | 135 |

TABLE 2

| | Particle | Halogen | | | | | | | | | | Total | |
|---|---|---|---|---|---|---|---|---|---|---|---|---|---|
| | size | aqueous solution | | | | | | | | | | amount | |
| | before | | Amount | Amount of acid added (part by mass) | | | | | | | | added | |
| | addition | | (part by | 0 | 30 | 60 | 90 | 120 | 150 | 180 | Stopped or | (part by | Coalescence |
| Toner | (μm) | Type | mass) | minutes | minutes | minutes | minutes | minutes | minutes | minutes | continuous | mass) | time (min) |
| 21 | 3.7 | Br | 60 | 12 | 12 | 12 | 12 | 9 | — | — | Stopped | 57 | 135 |
| 22 | 3.9 | Br | 60 | 12 | 12 | 12 | 12 | 9 | — | — | Stopped | 57 | 135 |
| 23 | 6.3 | Br | 60 | 12 | 12 | 12 | 12 | 9 | — | — | Stopped | 57 | 135 |
| 24 | 6.5 | Br | 60 | 12 | 12 | 12 | 12 | 9 | — | — | Stopped | 57 | 135 |
| 25 | 5.0 | Br | 8 | 12 | 12 | 12 | 12 | 9 | — | — | Stopped | 57 | 135 |
| 26 | 5.0 | Br | 4 | 12 | 12 | 12 | 12 | 9 | — | — | Stopped | 57 | 135 |
| 27 | 5.0 | Br | 60 | 9 | 12 | 12 | 12 | 12 | 6 | 6 | Stopped | 69 | 210 |
| 28 | 5.0 | Br | 60 | 9 | 12 | 12 | 9 | — | — | — | Stopped | 42 | 120 |
| 29 | 5.0 | F | 253 | 12 | 12 | 12 | 12 | 9 | — | — | Stopped | 57 | 135 |
| C1 | 5.0 | Br | 60 | 12 | 12 | 12 | 6 | — | — | — | Stopped | 42 | 105 |
| C2 | 5.0 | Br | 60 | 6 | 6 | 12 | 12 | 12 | 12 | — | Stopped | 60 | 135 |
| C3 | 5.0 | Br | 60 | 6 | 6 | 12 | 12 | 12 | 12 | 12 | Stopped | 72 | 210 |
| C4 | 5.0 | Br | 60 | 18 | 18 | 12 | 6 | — | — | — | Stopped | 54 | 135 |
| C5 | 5.0 | — | — | 12 | 12 | 12 | 12 | 9 | — | — | Continuous | 57 | 135 |

TABLE 3

| | | Low | High | | Number- | Specific | | | | | | |
|---|---|---|---|---|---|---|---|---|---|---|---|---|
| | | circularity | circularity | | average | size | | Halogen | Bromine | Chlorine | Iodine | |
| | | proportion | proportion | Ratio (low | particle | proportion | Average | amount | amount | amount | amount | |
| | | (% by | (% by | circularity/high | size | (% by | circu- | (mmol/100 | (% by | (% by | (% by | Evalu- |
| | Toner | number) | number) | circularity) | (μm) | number) | larity | g) | mass) | mass) | mass) | ation |
| Example | 1 | 0.5 | 72 | 0.007 | 6.2 | 78 | 0.969 | 1.88 | 0.15 | — | — | A |
| 1 | | | | | | | | | | | | |
| Example | 2 | 0.5 | 72 | 0.007 | 6.2 | 78 | 0.969 | 1.88 | — | 0.07 | — | A |
| 2 | | | | | | | | | | | | |
| Example | 3 | 1.6 | 69 | 0.023 | 6.3 | 76 | 0.967 | 1.88 | 0.15 | — | — | B |
| 3 | | | | | | | | | | | | |
| Example | 4 | 0.5 | 72 | 0.007 | 6.2 | 78 | 0.968 | 1.88 | — | — | 0.24 | B |
| 4 | | | | | | | | | | | | |
| Example | 5 | 1.3 | 72 | 0.018 | 6.3 | 78 | 0.968 | 1.88 | 0.15 | — | — | A |
| 5 | | | | | | | | | | | | |
| Example | 6 | 4.7 | 72 | 0.065 | 7.1 | 82 | 0.966 | 1.88 | 0.15 | — | — | C |
| 6 | | | | | | | | | | | | |
| Example | 7 | 0.5 | 59 | 0.008 | 6.8 | 65 | 0.962 | 1.88 | 0.15 | — | — | C |
| 7 | | | | | | | | | | | | |
| Example | 8 | 0.1 | 72 | 0.001 | 6.1 | 77 | 0.969 | 1.88 | 0.15 | — | — | C+ |
| 8 | | | | | | | | | | | | |
| Example | 9 | 0.5 | 80 | 0.006 | 6.2 | 86 | 0.971 | 1.88 | 0.15 | — | — | C |
| 9 | | | | | | | | | | | | |
| Example | 10 | 1.0 | 72 | 0.014 | 6.6 | 78 | 0.967 | 12.5 | 1.00 | — | — | B+ |
| 10 | | | | | | | | | | | | |
| Example | 11 | 1.2 | 71 | 0.017 | 6.6 | 77 | 0.965 | 13.75 | 1.10 | — | — | B |
| 11 | | | | | | | | | | | | |
| Example | 12 | 1.1 | 73 | 0.015 | 6.6 | 79 | 0.966 | 0.50 | 0.04 | — | — | B |
| 12 | | | | | | | | | | | | |

TABLE 4

| | | Low | High | | Number- | Specific | | | | | | |
|---|---|---|---|---|---|---|---|---|---|---|---|---|
| | | circularity | circularity | | average | size | | Halogen | Bromine | Chlorine | Iodine | |
| | | proportion | proportion | Ratio (low | particle | proportion | Average | amount | amount | amount | amount | |
| | | (% by | (% by | circularity/high | size | (% by | circu- | (mmol/100 | (% by | (% by | (% by | Evalu- |
| | Toner | number) | number) | circularity) | (μm) | number) | larity | g) | mass) | mass) | mass) | ation |
| Example | 13 | 1.1 | 73 | 0.015 | 6.7 | 79 | 0.967 | 0.63 | 0.05 | — | — | B+ |
| 13 | | | | | | | | | | | | |
| Example | 14 | 0.5 | 72 | 0.007 | 6.2 | 78 | 0.968 | — | — | — | — | C+ |
| 14 | | | | | | | | | | | | |
| Example | 15 | 1.0 | 72 | 0.014 | 6.5 | 78 | 0.969 | 3.75 | 0.30 | — | — | A |
| 15 | | | | | | | | | | | | |
| Example | 16 | 1.0 | 72 | 0.014 | 6.5 | 78 | 0.969 | 4.00 | 0.32 | — | — | B+ |
| 16 | | | | | | | | | | | | |
| Example | 17 | 1.0 | 72 | 0.014 | 6.5 | 78 | 0.969 | 1.25 | 0.10 | — | — | A |
| 17 | | | | | | | | | | | | |
| Example | 18 | 1.0 | 72 | 0.014 | 6.5 | 78 | 0.969 | 1.00 | 0.08 | — | — | B+ |
| 18 | | | | | | | | | | | | |
| Example | 19 | 0.8 | 72 | 0.011 | 5.6 | 78 | 0.968 | 1.88 | 0.15 | — | — | A |
| 19 | | | | | | | | | | | | |
| Example | 20 | 0.8 | 72 | 0.011 | 5.6 | 78 | 0.968 | 1.88 | 0.15 | — | — | A |
| 20 | | | | | | | | | | | | |
| Example | 21 | 0.8 | 72 | 0.011 | 4.3 | 78 | 0.968 | 1.88 | 0.15 | — | — | B+ |
| 21 | | | | | | | | | | | | |
| Example | 22 | 0.8 | 72 | 0.011 | 4.5 | 78 | 0.968 | 1.88 | 0.15 | — | — | A |
| 22 | | | | | | | | | | | | |
| Example | 23 | 0.8 | 72 | 0.011 | 7.5 | 78 | 0.968 | 1.88 | 0.15 | — | — | A |
| 23 | | | | | | | | | | | | |
| Example | 24 | 0.8 | 72 | 0.011 | 7.7 | 78 | 0.968 | 1.88 | 0.15 | — | — | B+ |
| 24 | | | | | | | | | | | | |

TABLE 5

| | | | | | | Specific | | | | | | |
|---|---|---|---|---|---|---|---|---|---|---|---|---|
| | | Low | High | | Number- | size | | | | | | |
| | | circularity | circularity | | average | propor- | | Halogen | Bromine | Chlorine | Iodine | |
| | | proportion | proportion | Ratio (low | particle | tion | Average | amount | amount | amount | amount | |
| | Ton- | (% by | (% by | circularity/high | size | (% by | circu- | (mmol/100 | (% by | (% by | (% by | Evalu- |
| | er | number) | number) | circularity) | (μm) | number) | larity | g) | mass) | mass) | mass) | ation |
| Example 25 | 25 | 0.5 | 72 | 0.007 | 6.2 | 78 | 0.969 | 0.25 | 0.02 | — | — | B+ |
| Example 26 | 26 | 0.5 | 72 | 0.007 | 6.2 | 78 | 0.969 | 0.10 | 0.01 | — | — | B |
| Example 27 | 27 | 0.3 | 79 | 0.004 | 6.1 | 84 | 0.974 | 1.88 | 0.15 | — | — | C+ |
| Example 28 | 28 | 0.7 | 59 | 0.012 | 6.3 | 65 | 0.957 | 1.88 | 0.15 | — | — | C+ |
| Example 29 | 29 | 0.5 | 72 | 0.007 | 6.2 | 78 | 0.969 | 1.88 | — | — | — | C |
| Comparative | C1 | 1.2 | 58 | 0.021 | 6.9 | 64 | 0.959 | 1.88 | 0.15 | — | — | D |
| Example 1 | | | | | | | | | | | | |
| Comparative | C2 | 0.05 | 67 | 0.0007 | 5.9 | 72 | 0.967 | 1.88 | 0.15 | — | — | D |
| Example 2 | | | | | | | | | | | | |
| Comparative | C3 | 0.5 | 81 | 0.006 | 6.0 | 87 | 0.974 | 1.88 | 0.15 | — | — | D |
| Example 3 | | | | | | | | | | | | |
| Comparative | C4 | 5.5 | 72 | 0.076 | 7.4 | 83 | 0.962 | 1.88 | 0.15 | — | — | D |
| Example 4 | | | | | | | | | | | | |
| Comparative | C5 | 0.09 | 74 | 0.001 | 6.2 | 79 | 0.970 | — | — | — | — | D |
| Example 5 | | | | | | | | | | | | |

From the above-described results, in the present example, the high-temperature and high-humidity solid image transferability is higher than that in the comparative examples.

The present exemplary embodiment includes the following aspects.

(((1)))

An electrostatic charge image developing toner comprising:
toner particles,
wherein, with respect to entire particles of the electrostatic charge image developing toner, an existence proportion of particles having a particle size of 4.5 μm or more and 7.5 μm or less and a circularity of less than 0.930 is 0.1% by number or more and 5.0% by number or less, and an existence proportion of particles having a particle size of 4.5 μm or more and 7.5 μm or less and a circularity of more than 0.950 and less than 0.990 is 59% by number or more and 80% by number or less.
   (((2)))

The electrostatic charge image developing toner according to (((1))),
wherein the toner particles contain a halogen element.
   (((3)))

The electrostatic charge image developing toner according to (((2))),
wherein an abundant amount of the halogen element per 100 g of the electrostatic charge image developing toner is 0.25 millimoles or more and 12.5 millimoles or less.
   (((4)))

The electrostatic charge image developing toner according to (((2))),
wherein the halogen element includes at least one selected from the group consisting of chlorine, bromine, and iodine.
   (5)

The electrostatic charge image developing toner according to any one of (((2))) to (((4))),
wherein the halogen element includes bromine.
   (((6)))

The electrostatic charge image developing toner according to (((5))),
wherein an abundant amount of the bromine is 0.02% by mass or more and 1.0% by mass or less with respect to an entire electrostatic charge image developing toner.
   (((7)))

The electrostatic charge image developing toner according to (((5))),
wherein an abundant amount of the bromine is 0.10% by mass or more and 0.30% by mass or less with respect to an entire electrostatic charge image developing toner.
   (((8)))

The electrostatic charge image developing toner according to any one of (((2))) to (((7))),
wherein the halogen element includes chlorine.
   (((9)))

The electrostatic charge image developing toner according to (((8))),
wherein an abundant amount of the chlorine is 0.009% by mass or more and 0.45% by mass or less with respect to an entire electrostatic charge image developing toner.
   (((10)))

The electrostatic charge image developing toner according to any one of (((1))) to (((9)))
wherein the existence proportion of the particles having a particle size of 4.5 μm or more and 7.5 μm or less and a circularity of less than 0.930 with respect to the entire particles of the electrostatic charge image developing toner is 0.1% by number or more and 1.5% by number or less.
   (((11)))

The electrostatic charge image developing toner according to any one of (((1))) to (((10))),
wherein a number-average particle size of the electrostatic charge image developing toner is 4.5 μm or more and 7.5 μm or less.
   (((12)))

The electrostatic charge image developing toner according to any one of (((1))) to (((11)),
wherein an average circularity of the electrostatic charge image developing toner is more than 0.95 and 0.99 or less.
   (((13)))

The electrostatic charge image developing toner according to any one of (((1))) to (((12))),
wherein the existence proportion of the particles having a particle size of 4.5 μm or more and 7.5 μm or less and a circularity of less than 0.930 is 0.001 times or more and 0.065 times or less of the existence proportion of the particles having a particle size of 4.5 μm or more and 7.5 μm or less and a circularity of more than 0.950 and less than 0.990.
   (((14)))

An electrostatic charge image developer comprising:
the electrostatic charge image developing toner according to any one of (((1))) to (((13))).
   (((15)))

A toner cartridge comprising: a container that contains the electrostatic charge image developing toner according to any one of (((1))) to (((13))), wherein the toner cartridge is detachable from an image forming apparatus.

(((16)))

A process cartridge comprising:
a developing device that contains the electrostatic charge image developer according to (((14))) and develops an electrostatic charge image formed on a surface of an image holder as a toner image using the electrostatic charge image developer,
wherein the process cartridge is detachable from an image forming apparatus.
   (((17)))

An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to (((14))) and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.
   (((18)))

An image forming method comprising:
charging a surface of an image holder;
forming an electrostatic charge image on the charged surface of the image holder;
developing the electrostatic charge image formed on the surface of the image holder as a toner image using the electrostatic charge image developer according to (((14)));
transferring the toner image formed on the surface of the image holder to a surface of a recording medium; and
fixing the toner image transferred to the surface of the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
toner particles,
wherein, with respect to entire particles of the electrostatic charge image developing toner, an existence proportion of particles having a particle size of 4.5 μm or more and 7.5 μm or less and a circularity of less than 0.930 is 0.1% by number or more and 5.0% by number or less, and an existence proportion of particles having a particle size of 4.5 μm or more and 7.5 μm or less and a circularity of more than 0.950 and less than 0.990 is 59% by number or more and 80% by number or less.

2. The electrostatic charge image developing toner according to claim 1,
wherein the toner particles contain a halogen element.

3. The electrostatic charge image developing toner according to claim 2,
wherein an abundant amount of the halogen element per 100 g of the electrostatic charge image developing toner is 0.25 millimoles or more and 12.5 millimoles or less.

4. The electrostatic charge image developing toner according to claim 2,
wherein the halogen element includes at least one selected from the group consisting of chlorine, bromine, and iodine.

5. The electrostatic charge image developing toner according to claim 2,
wherein the halogen element includes bromine, and
an abundant amount of the bromine is 0.02% by mass or more and 1.0% by mass or less with respect to an entire electrostatic charge image developing toner.

6. The electrostatic charge image developing toner according to claim 2,
wherein the halogen element includes chlorine.

7. The electrostatic charge image developing toner according to claim 6,
wherein an abundant amount of the chlorine is 0.009% by mass or more and 0.45% by mass or less with respect to an entire electrostatic charge image developing toner.

8. The electrostatic charge image developing toner according to claim 1,
wherein the existence proportion of the particles having a particle size of 4.5 μm or more and 7.5 μm or less and a circularity of less than 0.930 with respect to the entire particles of the electrostatic charge image developing toner is 0.1% by number or more and 1.5% by number or less.

9. The electrostatic charge image developing toner according to claim 1,
wherein the existence proportion of the particles having a particle size of 4.5 μm or more and 7.5 μm or less and a circularity of less than 0.930 is 0.001 times or more and 0.065 times or less of the existence proportion of the particles having a particle size of 4.5 μm or more and 7.5 μm or less and a circularity of more than 0.950 and less than 0.990.

10. An electrostatic charge image developer comprising:
the electrostatic charge image developing toner according to claim 1.

11. An electrostatic charge image developer comprising:
the electrostatic charge image developing toner according to claim 2.

12. An electrostatic charge image developer comprising:
the electrostatic charge image developing toner according to claim 3.

13. An electrostatic charge image developer comprising:
the electrostatic charge image developing toner according to claim 4.

14. An electrostatic charge image developer comprising:
the electrostatic charge image developing toner according to claim 5.

15. An electrostatic charge image developer comprising:
the electrostatic charge image developing toner according to claim 6.

16. An electrostatic charge image developer comprising:
the electrostatic charge image developing toner according to claim 7.

17. A toner cartridge comprising:
a container that contains the electrostatic charge image developing toner according to claim 1,
wherein the toner cartridge is detachable from an image forming apparatus.

18. A process cartridge comprising:
a developing device that contains the electrostatic charge image developer according to claim 10 and develops an electrostatic charge image formed on a surface of an image holder as a toner image using the electrostatic charge image developer,
wherein the process cartridge is detachable from an image forming apparatus.

19. An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to claim 10 and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.

20. An image forming method comprising:
charging a surface of an image holder;
forming an electrostatic charge image on the charged surface of the image holder;
developing the electrostatic charge image formed on the surface of the image holder as a toner image using the electrostatic charge image developer according to claim 10;
transferring the toner image formed on the surface of the image holder to a surface of a recording medium; and
fixing the toner image transferred to the surface of the recording medium.
